(19) United States
(12) Patent Application Publication
(10) Pub. No.: US 2025/0147550 A1
(43) Pub. Date: May 8, 2025

(54) METHOD FOR UNROLLING AND ROLLING ROLLABLE SCREEN AND RELATED PRODUCT

(71) Applicant: GUANGDONG OPPO MOBILE TELECOMMUNICATIONS CORP., LTD., Dongguan (CN)

(72) Inventors: Haizhou ZHU, Dongguan (CN); Zhiyi ZHOU, Dongguan (CN); Wenxi LI, Dongguan (CN); Rong ZHANG, Dongguan (CN)

(73) Assignee: GUANGDONG OPPO MOBILE TELECOMMUNICATIONS CORP., LTD., Dongguan (CN)

(21) Appl. No.: 19/009,476

(22) Filed: Jan. 3, 2025

Related U.S. Application Data
(63) Continuation of application No. PCT/CN2023/098899, filed on Jun. 7, 2023.

(30) Foreign Application Priority Data
Aug. 10, 2022 (CN) 202210964892.1

(51) Int. Cl. G06F 1/16; G06F 3/04883

(52) U.S. Cl. CPC G06F 1/1652; G06F 3/04883; G06F 2203/04808

(57) ABSTRACT

A method for unrolling and rolling a rollable screen. The method includes: starting a rollable screen motor in a case where a target gesture for a display screen meets a preset gesture; and determining a motion parameter of the rollable screen motor according to the target gesture, wherein the motion parameter is configured for indicate that the rollable screen is unrolled to a first preset state, or is closed to a second preset state.

### CROSS-REFERENCE TO RELATED APPLICATIONS

The present application is a continuation of International Patent Application No. PCT/CN2023/098899, filed on Jun. 7, 2023, which claims priority to Chinese Patent Application No. 202210964892.1, filed on Aug. 10, 2022, both of which are herein incorporated by reference in their entireties.

### TECHNICAL FIELD

The present disclosure relates to the technical field of electronic device, and in particular to a method for unrolling and rolling a rollable screen and related products.

### BACKGROUND

With development of electronic device technology, applications of electronic devices have become increasingly broad, and functions provided by the electronic devices have grown more diverse. The impact of user experience on a development direction of the electronic devices has become more significant, and screen size is a decisive factor in the user experience.

At present, a foldable display screen and a rollable screen are used to expand a display interface. However, a method for unrolling and rolling the rollable screen of the electronic device (such as a mobile phone, or a tablet computer, etc.) driven by electricity is relatively singular, for example, the rollable screen may be rolled and unrolled by manual dragging, which results in a low user experience. Therefore, there is an urgent need to provide a method for unrolling and rolling the rollable screen, so as to achieve diversity in unrolling and rolling the display screen of the electronic device that adopts the rollable screen driven by electricity.

### SUMMARY OF THE DISCLOSURE

The embodiments of the present disclosure provide a method for unrolling and rolling a rollable screen and related products.

In a first aspect, the embodiments of the present disclosure provide a method for unrolling and rolling a rollable screen. The method includes the following operations:
starting a rollable screen motor in a case where a target gesture for a display screen meets a preset gesture; and
determining a motion parameter of the rollable screen motor according to the target gesture, wherein the motion parameter is configured to indicate that the rollable screen is unrolled to a first preset state or is closed to a second preset state.

In a second aspect, the embodiments of the present disclosure provide an electronic device. The electronic device includes a processor, a memory, a communication interface, and one or more programs. The one or more programs are stored in the memory and configured to be executed by the processor, the programs include instructions for executing operations in any method of the first aspect of the present disclosure.

In a third aspect, the embodiments of the present disclosure provide a computer-readable storage medium, the computer-readable storage medium stores a computer program configure for electronic data interchange, and the computer program allows a computer to execute some or all of the operations in any method of the first aspect of the present disclosure.

### BRIEF DESCRIPTION OF THE DRAWINGS

In order to more clearly illustrate the technical solutions in some embodiments of the present disclosure, hereinafter, the accompanying drawings that are used in the description of some embodiments or the related art will be briefly described. Obviously, the accompanying drawings in the description below are merely the accompanying drawings in some embodiments of the present disclosure. For those of ordinary skill in the art, other accompanying drawings may be obtained according to these accompanying drawings without any creative efforts.

FIG. 1 is a structural schematic view of an electronic device in some embodiments of the present disclosure.

FIG. 2 is a structural schematic view illustrating software of the electronic device in some embodiments of the present disclosure.

FIG. 3A is a structural schematic view of a rollable screen in some embodiments of the present disclosure.

FIG. 3B is a structural schematic view of the rollable screen in some embodiments of the present disclosure.

FIG. 4 is a flowchart illustrating a method for unrolling and rolling the rollable screen in some embodiments of the present disclosure.

FIG. 5A is a schematic view illustrating interaction between a target gesture and the electronic device in some embodiments of the present disclosure.

FIG. 5B is a schematic view illustrating the interaction between the target gesture and the electronic device in some embodiments of the present disclosure.

FIG. 5C is a schematic view illustrating the interaction between the target gesture and the electronic device in some embodiments of the present disclosure.

FIG. 5D is a schematic view illustrating the interaction between the target gesture and the electronic device in some embodiments of the present disclosure.

FIG. 6 is a schematic view illustrating gestures for unrolling and rolling the rollable screen in some embodiments of the present disclosure.

FIG. 7 is a flowchart illustrating a method for unrolling and rolling the rollable screen in some embodiments of the present disclosure.

FIG. 8 is a structural schematic view of an electronic device in some embodiments of the present disclosure.

FIG. 9A is a functional unit composition block view of a rollable screen unrolling and rolling device in some embodiments of the present disclosure.

FIG. 9B is a functional unit composition block view of a rollable screen unrolling and rolling device in some embodiments of the present disclosure.

### DETAILED DESCRIPTION

In order to allow those of ordinary skill in the art to better understand the technical solutions of the present disclosure, the technical solutions in some embodiments of the present disclosure may be clearly and completely described in conjunction with accompanying drawings in some embodiments of the present disclosure. Obviously, the described embodiments are only a part of the embodiments of the present disclosure, and not all embodiments. According to the embodiments in the present disclosure, all other embodiments obtained by those of ordinary skill in the art without creative effort are within the scope of the present disclosure.

The terms “first”, “second”, etc. of specification, claims, and the accompanying drawings of the present disclosure, are configured to distinguish different objects and do not describe a specific order. In addition, the terms “including”, “comprising”, and “having”, as well as any variations of the terms “including”, “comprising”, and “having”, are intended to cover non-exclusive inclusions. For example, a process, method, system, product, or device that includes a series of operations or units is not limited to the listed operations or units, but optionally includes operations or units that are not listed, or optionally includes other operations or units that are inherent to these processes, methods, products, or devices.

The reference to “embodiment” in the present disclosure means that, specific features, structures, or characteristics described in conjunction with some embodiments may be included in at least one embodiment of the present disclosure. The phrase appearing in various positions in the specification does not necessarily refer to the same embodiment, nor is it an independent or alternative embodiment that is mutually exclusive with other embodiments. Those of ordinary skill in the art explicitly and implicitly understand that the embodiments described in the present disclosure can be combined with other embodiments.

An electronic device may be a portable electronic device that further include other functions such as a personal digital assistant and/or a music player. The electronic device may be a mobile phone, a tablet computer, a wearable electronic device with a wireless communication function (such as a smartwatch, smart glasses), or an in-car device, etc. An exemplary embodiment of the portable electronic device includes but are not limited to the portable electronic device with an IOS system, an Android system, a Microsoft system, or other operating systems. The above portable electronic device may also be other portable electronic devices, such as a laptop. In some other embodiments, the above electronic device may not be the portable electronic device, but a desktop computer.

The software and hardware operating environment of the technical solution in the present disclosure is introduced as follows.

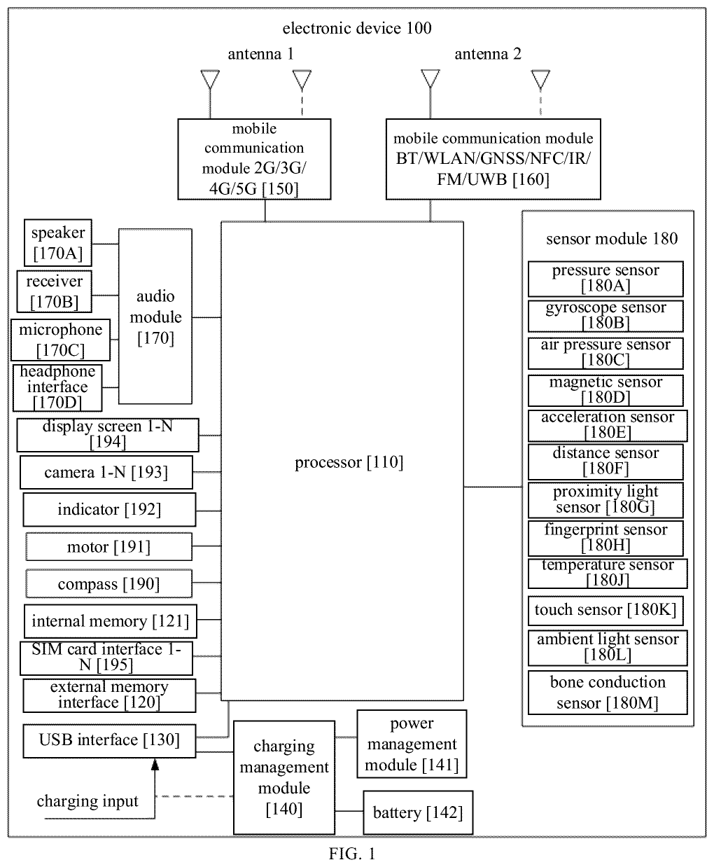

In some embodiments, FIG. 1 shows a structural schematic view of an electronic device 100. The electronic device 100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headphone interface 170D, a sensor module 180, a compass 190, a motor 191, an indicator 192, a camera 193, a display screen 194, and a subscriber identification module (SIM) card interface 195, etc.

In some embodiments, the structure illustrated in the embodiments of the present disclosure does not constitute a specific limitation on the electronic device 100. In some embodiments of the present disclosure, the electronic device 100 may include more or fewer components than components illustrated in FIG. 1, combine certain components, split certain components, or have different arrangement of the components. The illustrated components may be implemented in hardware, software, or a combination of the software and the hardware.

The processor 110 may include one or more processing units, such as an application processor (AP), a modulation and demodulation processor, a graphics processing unit (GPU), an image signal processor (ISP), a controller, a video codec, a digital signal processor (DSP), a baseband processor, and/or a neural-network processing unit (NPU), etc. The different processing units may be independent components or integrated into one or more processors. In some embodiments, the electronic device 100 may further include one or more processors 110. The controller may generate operation control signals according to instruction operation codes and timing signals, so as to complete control of instruction fetching and instruction execution. In some embodiments, the memory may also be provided in the processor 110 and configured for storing instructions and data. In some embodiments, the memory of the processor 110 may be a cache memory. The memory may store the instructions or the data that have just been used or recycled by the processor 110. When the processor 110 needs to use the instruction or the data again, the instruction or the data may be directly called from the memory. It avoids duplicate access, reduces waiting time of the processor 110, thereby improving efficiency of the electronic device 100 in processing the data or executing the instructions.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, the SIM card interface, and/or the USB interface. The USB interface 130 is an interface that complies with a USB standard specification, and the USB interface 130 may be a Mini USB interface, a Micro USB interface, a USB Type C interface, etc. The USB interface 130 may be configured to be connected to a charger, so as to charge the electronic device 100. The USB interface 130 may transfer the data between the electronic device 100 and a peripheral device. The USB interface 130 may also be configured to be connected to a headphone, so that playing audio is performed through the headphone.

In some embodiments, an interface connection relationship between the modules illustrated in the embodiments of the present disclosure is only a schematic description and does not constitute a structural limitation on the electronic device 100. In some embodiments of the present disclosure, the electronic device 100 may also adopt an interface connection mode that is different from the interface connection mode described in the above embodiments or a combination of multiple interface connection modes.

The charging management module 140 is configured to receive a charging input from the charger. The charger may be a wireless charger or a wired charger. In some embodiments of wired charging, the charging management module 140 may receive the charging input from the wired charger through the USB interface 130. In some embodiments of wireless charging, the charging management module 140 may receive a wireless charging input through a wireless charging coil of the electronic device 100. The charging management module 140 may charge the battery 142 and also provide power to the electronic device through the power management module 141.

The power management module 141 is configured to be connected to the battery 142, the charging management module 140, and the processor 110. The power management module 141 receives an input from the battery 142 and/or an input from the charging management module 140, thereby providing power to the processor 110, the internal memory 121, the external memory, display screen 194, the camera 193, and the wireless communication module 160. The power management module 141 may also be configured to monitor parameters, such as battery capacity, battery cycle times, battery health status (leakage, impedance), etc. In some embodiments, the power management module 141 may also be disposed in the processor 110. In some embodiments, the power management module 141 and the charging management module 140 may also be disposed in the same device.

The wireless communication function of the electronic device 100 may be achieved through the antenna 1, the antenna 2, the mobile communication module 150, the wireless communication module 160, the modulation and demodulation processor, and the baseband processor.

The antenna 1 and the antenna 2 are configured for transmitting and receiving electromagnetic wave signals. Each antenna of the electronic device 100 may be configured to cover a single or multiple communication frequency bands. Different antennas may also be reused, so as to improve utilization of the antenna. In some embodiments, the antenna 1 may be reused as a diversity antenna for a wireless local area network. In some embodiments, the antenna may be used in conjunction with a tuning switch.

The mobile communication module 150 may provide a solution of the wireless communication applied to the electronic device 100, and the wireless communication includes 2G, 3G, 4G, or 5G, etc. The mobile communication module 150 may include at least one filter, a switch, a power amplifier, a low noise amplifier (LNA), etc. The mobile communication module 150 may receive an electromagnetic wave by the antenna 1, process the received electromagnetic wave such as filtering and amplifying the received electromagnetic wave, and transmit the electromagnetic wave to the modulation and demodulation processor for demodulation. The mobile communication module 150 may also amplify a signal modulated by the modulation and demodulation processor, and convert the signal into the electromagnetic wave through the antenna 1 for radiation. In some embodiments, at least some functional modules of the mobile communication module 150 may be disposed in the processor 110. In some embodiments, at least some functional modules of the mobile communication module 150 and at least some modules of the processor 110 may be disposed in the same device.

The wireless communication module 160 may provide the solution of the wireless communication applied to the electronic device 100, and the wireless communication includes the wireless local area network (WLAN) (such as a wireless fidelity (Wi-Fi) network), a Bluetooth (BT), a global navigation satellite system (GNSS), frequency modulation (FM), a near field communication (NFC) technology, an infrared (IR) technology, an ultra-wide band (UWB), etc. The wireless communication module 160 may be one or more devices that integrate at least one communication processing module. The wireless communication module 160 receives the electromagnetic wave through the antenna 2, modulates and filters an electromagnetic wave signal, and sends the processed signal to the processor 110. The wireless communication module 160 may also receive a signal to be transmitted from the processor 110, perform frequency modulation on the signal to be transmitted, amplify the signal to be transmitted, and convert the signal to be transmitted into the electromagnetic wave through the antenna 2 for radiation.

The electronic device 100 achieves a display function through the GPU, the display screen 194, and the application processor. The GPU is a microprocessor for relationship analysis, which connects the display screen 194 and the application processor. The GPU is configured for performing mathematical and a geometric calculation, and configured for graphic rendering. The processor 110 may include one or more GPUs that execute a program instruction to generate or modify display information.

The display screen 194 is configured to a display image, a video, etc. The display screen 194 includes a display panel. The display panel may adopt a liquid crystal display (LCD), an organic light-emitting diode (OLED), an active-matrix organic light-emitting diode (AMOLED), a flexible light-emitting diode (FLED), a mini light-emitting diode (miniLED), a MicroLED, a Micro-OLED, a quantum dot light-emitting diode (QLED), etc. In some embodiments, the electronic device 100 may include one or more display screens 194.

The electronic device 100 may achieve a shooting function through the ISP, the camera 193, the video codec, the GPU, the display screen 194, and the application processor.

The ISP is configured to process the data fed back by the camera 193. In some embodiments, when taking a photo, a shutter is opened and light is transmitted through a lens to a photosensitive element of a camera. Light signals are converted into electrical signals, and the electrical signals are transmitted to the ISP by the photosensitive element of the camera for processing, thereby converting into the image that is visible to the naked eye. The ISP may also optimize algorithms for noise, brightness, and skin tone of the image. The ISP may also optimize parameters such as exposure and a color temperature of a shooting scene. In some embodiments, the ISP may be disposed in the camera 193.

The camera 193 is configured to capture a static image or a static video. The object generates an optical image through the lens and projects the optical image onto the photosensitive element. The photosensitive element may be a charge coupled device (CCD) or a complementary metal-oxide-semiconductor (CMOS) phototransistor. The photosensitive element converts the optical signal into the electrical signal, and then transmits the electrical signal to the ISP, so that the electrical signal is converted into a digital image signal. The ISP outputs the digital image signal to the DSP for processing. The DSP converts the digital image signal into the image signal with a standard format, such as RGB, YUV, etc. In some embodiments, the electronic device 100 may include one or more cameras 193.

The digital signal processor is configured to process the digital signal. In addition to processing the digital image signal, the digital signal processor may also process other digital signals. In some embodiments, when the electronic device 100 selects a frequency point, the digital signal processor is configured to perform Fourier transform on energy of the frequency point, etc.

The video codec is configured for compressing or decompressing a digital video. The electronic device 100 may support one or more video codecs. In this way, the electronic device 100 may play or record videos in various encoding formats, such as moving pictures experts group (MPEG) 1, MPEG 2, MPEG 3, MPEG 4, etc.

The NPU is a neural-network (NN) computing processor. The NN computing processor can quickly process input information by learning from a biological neural network structure, such as learning from a transmission mode between neurons in a human brain. The NN computing processor is also capable of continuous self-learning. The intelligent cognition for the electronic device 100 can be achieved by the NPU, and the intelligent cognition may be image recognition, facial recognition, speech recognition, text understanding, etc.

The external memory interface 120 may be configured to be connected to an external storage card, such as a Micro SD card, so as to expand storage capacity of the electronic device 100. The external memory card communicates with the processor 110 through the external memory interface 120, so as to achieve a data storage function, such as, saving a music, a video, and other files on the external storage card.

The internal memory 121 may be configured to store one or more computer programs, and one or more computer programs includes instructions. The processor 110 can execute the above instructions stored in the internal memory 121, so that the electronic device 100 can execute the methods of displaying page elements in some embodiments of the present disclosure, various applications and data processing, etc. The internal memory 121 may include a storage program area and a storage data area. The storage program area may store an operating system. The storage program area may also store one or more applications, such as a gallery, contacts, etc. The storage data area may store data created during use of the electronic device 100, such as photos, contacts, etc. In addition, the internal memory 121 may include high-speed random access memory, and non-volatile memory, such as one or more disk storage components, flash memory components, universal flash storage (UFS), etc. In some embodiments, the processor 110 can run the instructions stored in the internal memory 121 and/or the instructions stored in the memory of the processor 110, so that the electronic device 100 executes the method for displaying page elements in the embodiments of the present disclosure, other applications and the data processing. The electronic device 100 may achieve an audio function through the audio module 170, the speaker 170A, the receiver 170B, the microphone 170C, the headphone interface 170D, and the application processor. In some embodiments, the audio function may be music playback, recording, etc.

The sensor module 180 may include a pressure sensor 180A, a gyroscope sensor 180B, an air pressure sensor 180C, a magnetic sensor 180D, an acceleration sensor 180E, a distance sensor 180F, a proximity light sensor 180G, a fingerprint sensor 180H, a temperature sensor 180J, a touch sensor 180K, an ambient light sensor 180L, a bone conduction sensor 180M, etc.

The pressure sensor 180A is configured to sense a pressure signal and may convert the pressure signal into the electrical signal. In some embodiments, the pressure sensor 180A may be disposed on the display screen 194. There are many types of pressure sensors 180A, such as a resistive pressure sensor, an inductive pressure sensor, a capacitive pressure sensor, etc. The capacitive pressure sensor may include at least two parallel plates with conductive materials. When a force is applied to the pressure sensor 180A, capacitance between electrodes changes. The electronic device 100 determines a strength of pressure according to changes in the capacitance. When a touch operation is applied to the display screen 194, the electronic device 100 detects a touch operation intensity according to the pressure sensor 180A. The electronic device 100 may also calculate a touch position according to a detection signal of the pressure sensor 180A. In some embodiments, touch operations with different touch operation intensities applied to the same touch position may correspond to different operation instructions. In some embodiments, when the touch operation with the touch operation intensity less than a first pressure threshold is applied to a short message application icon, the instruction to view a short message is executed. When the touch operation with the touch operation intensity greater than or equal to the first pressure threshold is applied to the short message application icon, the instruction to create a new short message is executed.

The gyroscope sensor 180B may be configured to determine a motion posture of the electronic device 100. In some embodiments, angular velocities of the electronic device 100 around three axes (i.e., X, Y, and Z axes) may be determined by the gyroscope sensor 180B. The gyroscope sensor 180B may be configured for image stabilization during photography. In some embodiments, when the shutter is pressed, the gyroscope sensor 180B detects an angle of shaking of the electronic device 100, calculates a distance that a lens module needs to compensate according to the angle, and allows the lens to move in reverse, so as to counteract the shaking of the electronic device 100, achieving anti-shake. The gyroscope sensor 180B may also be configured for navigation and somatosensory game scenes.

The acceleration sensor 180E may detect magnitude of acceleration of the electronic device 100 in various directions (usually three-axis). When the electronic device 100 is stationary, magnitude and a direction of gravity may be detected. The acceleration sensor 180E may also be configured to recognize the posture of the electronic device. The acceleration sensor 180E may be applied to the application, such as horizontal and vertical screen switching, a pedometer, etc.

The ambient light sensor 180L is configured to sense the brightness of ambient light. The electronic device 100 may adaptively adjust the brightness of the display screen 194 according to the perceived ambient light brightness. The ambient light sensor 180L may also be configured to automatically adjust white balance when taking the photo. The ambient light sensor 180L may also be combined with the proximity light sensor 180G, so as to detect that the electronic device 100 is in a pocket, thereby preventing accidental contact.

The fingerprint sensor 180H is configured to collect a fingerprint. The electronic device 100 may utilize collected fingerprint characteristics to implement functions, such as fingerprint unlocking, accessing an application lock, taking the photo with fingerprint authentication, answering a call with fingerprint recognition, etc.

The temperature sensor 180J is configured to detect a temperature. In some embodiments, the electronic device 100 utilizes the temperature sensor 180J to detect temperature and execute a temperature processing strategy. In some embodiments, when the temperature reported by the temperature sensor 180J exceeds the threshold, the electronic device 100 reduces the performance of the processor located near the temperature sensor 180J, so as to reduce power consumption and implement thermal protection. In some embodiments, when the temperature is less than another threshold, the electronic device 100 heats the battery 142, so as to avoid abnormal shutdown of the electronic device 100 due to low temperature. In some embodiments, when the temperature is less than yet another threshold, the electronic device 100 increases an output voltage of the battery 142, so as to avoid abnormal shutdown caused by the low temperature.

The touch sensor 180K is also known as “touch panel”. The touch sensor 180K may be disposed on the display screen 194. The touch sensor 180K and the display screen 194 form the touch screen. The touch sensor 180K is configured to detect the touch operation acting on the touch screen or near the touch screen. The touch sensor 180K may transmit detected touch operation to the application processor, so as to determine a type of a touch event. Visual output related to the touch operation may be provided through the display screen 194. In some embodiments, the touch sensor 180K may also be disposed on a surface of the electronic device 100, which is different from a position of the display screen 194.

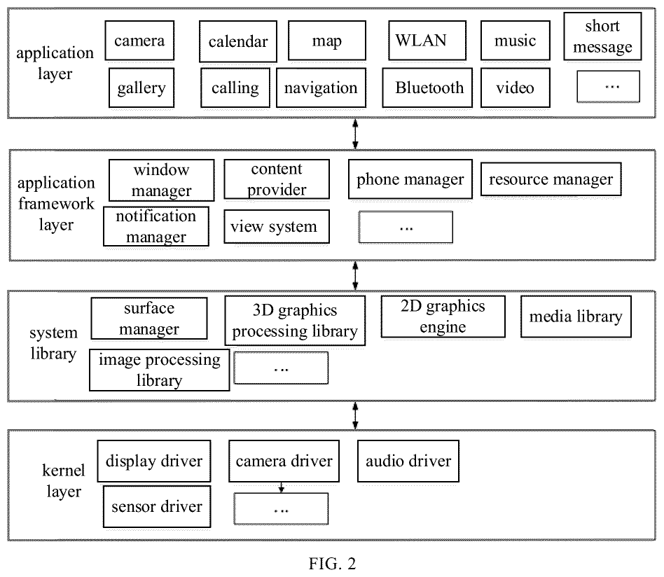

In some embodiments, FIG. 2 shows an architecture block view illustrating software of the electronic device 100. A layered architecture divides the software into several layers, each layer has a clear role and division of labor. The layers communicate with each other through software interfaces. In some embodiments, the Android system is divided into four layers, from top to bottom, the four layers are an application layer, an application framework layer, an Android runtime and system library, and a kernel layer. The application layer may include a series of application packages.

As illustrated in FIG. 2, the application package may include the application, such as the camera, the gallery, a calendar, a calling, a map, the navigation, the WLAN, the Bluetooth, the music, the video, the short message, etc.

The application framework layer provides an application programming interface (API) and a programming framework for the application of the application layer. The application framework layer includes some pre-defined functions.

As illustrated in FIG. 2, the application framework layer may include a window manager, a content provider, a view system, a phone manager, a resource manager, a notification manager, etc.

The window manager is configured to manage window programs. The window manager may obtain a size of the display screen, determine that there is a status bar, lock the screen, capture the screen, etc.

The content provider is configured to store and retrieve the data, and allow the data to be accessed by the application. The data may include the video, the image, the audio, call made and received, browsing history and a bookmark, a phone book, etc.

The view system includes a visual control, such as a control for displaying the text, a control for displaying the image, etc. The view system may be configured to build the application. A display interface may be composed of one or more views, such as the display interface including a short message notification icon, the view displaying the text, and the view displaying the image.

The telephone manager is configured to provide a communication function for the electronic device 100, such as the management of call status (including connection, disconnection, etc.).

The resource manager provides various resources for the application, such as a localized string, the icon, the image, a layout file, a video file, etc.

The notification manager enables the application to display notification information in the status bar, which may be configured to convey a notification type message, and may automatically disappear after a brief pause without user interaction. For example, the notification manager is configured to inform download completion, message reminders, etc. The notification manager may also be the notification that appears in a top status bar of the system in the form of charts or scrollbar text, such as the notification for the application running in the background. The notification manager may also be the notification that appears on the screen in the form of a dialogue window, such as, displaying the text message in the status bar, emitting an alert sound, vibration of the electronic device, flashing of the indicator light, etc.

The Android runtime includes a core library and a virtual machine. The Android runtime is responsible for scheduling and managing the Android system.

The core library includes two parts: one part is functional functions that Java language needs to call, and the other part is the Android core library.

The application layer and the application framework layer run in the virtual machine. The virtual machine executes a Java file of the application layer and application framework layer as a binary file. The virtual machine is configured for performing the function, such as, object lifecycle management, stack management, thread management, security and exception management, and garbage collection, etc.

The system library may include multiple functional modules, such as, a surface manager, a media library, a 3D graphics processing library (such as OpenGL ES), a 2D graphics engine (such as SGL), etc.

The surface manager is configured to manage a display subsystem and provides a fusion of 2D and 3D layers for multiple applications.

The media library supports playback and recording of various commonly used audio and video formats, and a static image file. The media library may support multiple audio and video encoding formats, such as MPEG4, H.264, MP3, AAC, AMR, JPG, PNG, etc.

The 3D graphics processing library is configured to implement 3D graphics drawing, image rendering, compositing, and layer processing, etc.

The 2D graphics engine is a drawing engine for 2D drawing.

The kernel layer is the layer between the hardware and the software. The kernel layer at least includes a display driver, a camera driver, an audio driver, and a sensor driver.

In a first part, example application scenarios in the embodiments of the disclosure are described as follows.

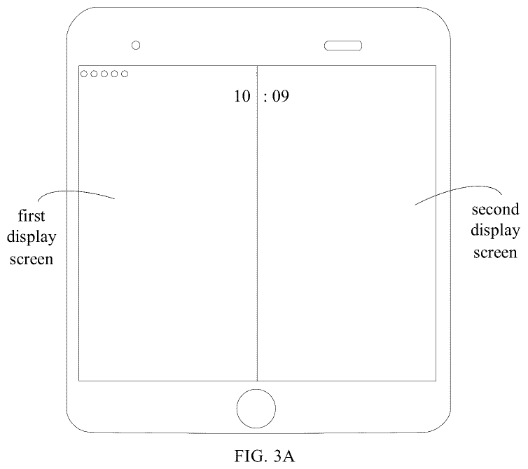

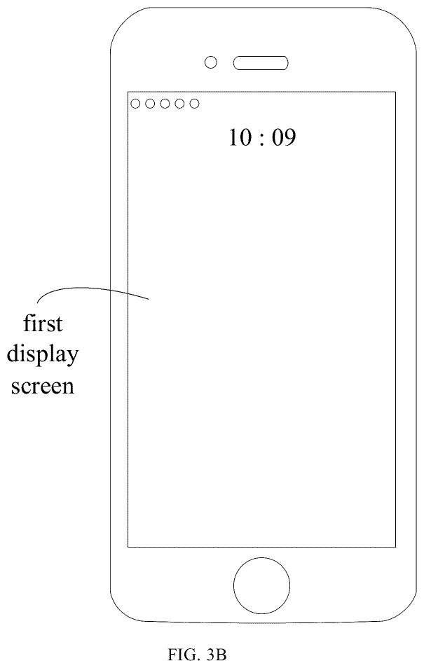

FIG. 3A shows a structural schematic view of a rollable screen applicable to the present disclosure, which may include a first display screen and a second display screen.

As illustrated in FIG. 3A, the first display screen may be a main display screen, and the second display screen is the rollable screen in the embodiments of the present disclosure. When the second display screen is fully unrolled, the display screen state illustrated in FIG. 3A may be presented. The first display screen and the second display screen may be configured to display the same application interface or different application interfaces.

As illustrated in FIG. 3B, FIG. 3B is a structural schematic view of a rollable screen. When the second display screen (the rollable screen) is closed (that is, the rollable screen is fully rolled), the electronic device may only include the first display screen, and the user may use the first display screen.

The first display screen and/or the second display screen may receive a gesture operation of the user on it, i.e., a target gesture. The target gesture may include at least one of the following: a click gesture, a slide gesture, a press gesture, etc., which is not limited here.

In some embodiments, the user may perform the gesture operation on the first display screen and/or the second display screen. The electronic device may respond to the target gesture for the first display screen and/or the second display screen, and determine that the target gesture meets a preset gesture. When the target gesture meets the preset gesture, a rollable screen motor is started. According to the target gesture, a motion parameter of the rollable screen motor is determined. The motion parameter is configured to indicate that the rollable screen (the second display screen) is unroll to the first preset state or closed to the second preset state. In this way, the rollable screen motor may be controlled through the gesture, so as to start the rollable screen, which is beneficial for improving the user experience.

In the present disclosure, the term “multiple” may refer to two or more, which is not repeated later.

In a second part, a protected range of claims of the embodiments of the present disclosure are described as follows.

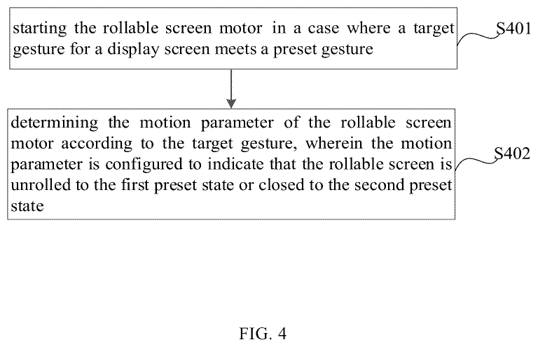

As illustrated in FIG. 4, FIG. 4 is a flowchart illustrating a method for unrolling and rolling the rollable screen in some embodiments of the present disclosure, which is applied to the electronic device. As illustrated in FIG. 4, the method for unrolling and rolling the rollable screen includes the following operations.

At block S401, the method may include starting the rollable screen motor in a case where a target gesture for a display screen meets a preset gesture.

The preset gesture may be set by the user himself or by the system default. The preset gesture may refer to a valid gesture for correctly starting the rollable screen motor. The second display screen (the rollable screen) illustrated in FIG. 3A can be rolled and/or unrolled through the rollable screen motor.

At block S402, the method may include determining the motion parameter of the rollable screen motor according to the target gesture, wherein the motion parameter is configured to indicate that the rollable screen is unrolled to the first preset state or closed to the second preset state.

The motion parameter may include at least one of the following: a motion speed, a motion direction, vibration feedback corresponding to different motion directions, etc. According to the gesture parameter corresponding to the target gesture, the motion speed and the motion direction of rolling or unrolling the rollable screen driven by the rollable screen motor may be determined. As illustrated in FIG. 3A, it is the first preset state of the rollable screen, i.e., an unrolled state. As illustrated in FIG. 3B, it is the second preset state of the rollable screen, i.e., a closed state or a fully rolled state, etc.

In order to make it easier for the user to perceive that the rollable screen is unrolling or rolling, different vibration frequencies may be set, and the electronic device may be controlled to vibrate through the vibration frequency, so that the user may perceive that the current rollable screen is in the unrolled state or the closed state for the first time.

When the target gesture meets the preset gesture, the vibration feedback may be given to the user, so as to indicate that the current gesture is the valid gesture.

In some embodiments, when the gesture parameter includes a pressure value of pressing the display screen, and the pressure value of pressing the display screen reaches a preset pressure threshold, the motion speed corresponding to the pressure value can be determined according to the mapping relationship between the preset pressure value and the motion speed. When the pressure value is larger, the motion speed may be set to be larger. In this way, according to the pressure value of the user pressing the display screen, as the pressure value gradually increases, the motion speed adaptively controlling the rollable screen is gradually increase until the rollable screen is fully unrolled. It may better adapt to the user's needs, which is conducive to improving the user experience. The user can observe the process of unrolling the rollable screen, thereby increasing the fun of unrolling the rollable screen.

In the method for unrolling and rolling the rollable screen in the embodiments of the present disclosure, the target gesture meeting the preset gesture is determined in response to the target gesture for the display screen, the rollable screen motor is started when the target gesture meets the preset gesture, and the motion parameter of the rollable screen motor is determined according to the target gesture. The motion parameter is configured to indicate that the rollable screen is unrolled to the first preset state or closed to the second preset state. In this way, the control of the rollable screen motor may be achieved through the gesture, so as to start the rollable screen, which is beneficial for improving the user experience.

In some embodiments, a method for determining that the target gesture meets the preset gesture may include the following operations: determining the gesture parameter of the target gesture; determining a gesture type of the target gesture according to the gesture parameter; and determining that the target gesture meets the preset gesture according to the gesture type and/or the gesture parameter.

The gesture type may be set by the user himself or by the system default, which is not limited here. The gesture type may include a finger gesture, such as a single finger gesture or a multi-finger gesture. In some embodiments, the gesture type may include single finger pressing, multi-finger pressing, multi-finger clicking, multi-finger sliding, or multi-finger hover sliding, etc., which is not limited here.

The gesture type may also include a palm gesture type on a lateral palm, a palm surface, or other parts. In some embodiments, the palm gesture type includes sliding to the left, right, up, or down on the display screen with the lateral palm of a left hand or the lateral palm of a right hand, either in contact or hovering.

The gesture parameter may include at least one of the following: the number of the pressing points, a pressing area, a fingerprint and/or a palm print of a hand pressing the display screen, a pressing duration, a sliding displacement, the sliding direction, a sliding shape, a moving path, an angle between the gesture and a horizontal plane, and whether it is the first operation, etc., which are not limited here.

The gesture parameter may be specifically adapted according to the gesture type. In some embodiments, when the gesture type is the palm gesture type, the gesture parameter may include at least one of the following: a palm moving range, a palm moving direction, the moving path formed in the palm moving range, the angle formed between the palm and a horizontal line during moving the palm, and a palm moving distance, etc. In some embodiments, when the gesture parameter obtained by the electronic device is any one or more of the above gesture parameters, it is determined that the gesture type of the target gesture is the palm gesture type.

In some embodiments, the gesture type may be determined according to the gesture parameter, the target gesture meeting the preset gesture, that is, the target gesture action being valid, may be determined according to the gesture type and the gesture parameter. It is conducive to quickly locating other gesture parameters required for the gesture type, and to quickly locating specific judgment conditions (such as the conditions for the above gesture parameters to meet the standard) when determining that the gesture is valid later. It is conducive to reducing time for the gesture recognition and improving efficiency of unrolling and/or closing the rollable screen.

In some embodiments, when the gesture parameter includes the number of the pressing points and the pressing area, the method for determining the gesture type of the target gesture according to the gesture parameter may include the following operations: when the number of the pressing points is greater than first preset number of the pressing points and less than second preset number of the pressing points, the gesture type of the target gesture is determined to be a finger gesture type; when the number of the pressing points is less than the first preset number of the pressing points, or when the number of the pressing points is greater than or equal to the second preset number of the pressing points, and the pressing area is greater than a preset pressing area, the gesture type of the target gesture is determined to be the palm gesture type.

The first preset number of the pressing points and/or the second preset number of the pressing points, and the preset pressing area, are all set by the user himself or by the system default, which are not limited here.

The first preset number of the pressing points is less than the second preset number of the pressing points. In general, since most users prefer to use a single-handed multi-finger pressing gesture or double handed thumb pressing gestures, the first preset number of the pressing points may be set to 1, the second preset number of the pressing points may be set to 4, and the preset pressing area may be a pixels. The preset pressing area may be set as the minimum contact area between the palm and the display screen corresponding to the palm gesture type, which may be described by pixel points in the display screen.

In some embodiments, the number of the pressing points when hovering or pressing the display screen by the finger is different from the number of the pressing points when hovering or pressing the display screen by the palm. In the case where both the palm and the finger press the display screen, the number of the pressing points when pressing the display screen by the finger is significantly greater than the number of the pressing points when pressing the display screen by the palm. When the gesture of the finger or the palm is the hovering gesture, the number of the pressing points mapped from the palm to the display screen may be significantly greater than the number of the pressing points mapped from the finger to the display screen. Therefore, when the number of the pressing points is greater than the first preset number of the pressing points and less than the second preset number of the pressing points, it indicates that the gesture type of the target gesture may be the finger gesture type. The gesture type of the target gesture may be the palm gesture type or four finger parallel pressing on the display screen. In this case, it may be difficult to distinguish the number of the pressing points. Therefore, when the number of the pressing points is less than the first preset number of the pressing points, or when the number of the pressing points is greater than or equal to the second preset number of the pressing points, and the pressing area is greater than the preset pressing area, the gesture type of the target gesture is determined to be the palm gesture type. Otherwise, the gesture type of the target gesture is determined to be the finger gesture type.

Therefore, in the present embodiment, the electronic device does not need to obtain all gesture parameters, and can determine the gesture type of the target gesture through only a few gesture parameters. In the subsequent operations, the gesture parameters can be further adapted according to the gesture type. Finally, according to the gesture type and corresponding gesture parameters, it can be further determined that the target gesture meets the preset gesture. In this way, it is beneficial to quickly locate specific judgment conditions (such as the conditions for the gesture parameters to meet the standard) when determining that the gesture is valid later. It is conducive to reducing the time for the gesture recognition and improving the efficiency of unrolling and/or closing the rollable screen.

In some embodiments, when the gesture type of the target gesture is the finger gesture type, the gesture parameter includes at least one of the following: multiple pressing positions, the pressing area corresponding to each pressing position, the pressing duration corresponding to each pressing position, the sliding direction corresponding to each pressing position, and the sliding displacement corresponding to each pressing position. The method for determining that the target gesture meets the preset gesture according to the gesture type and/or the gesture parameter may include the following operations: when the multiple pressing positions are all in a preset pressing range and it is determined that the target gesture has not undergone sliding displacement, the target gesture is determined to be a first finger gesture type. According to a mapping relationship between a preset finger gesture type and a mistouch parameter, a first mistouch parameter corresponding to the first finger gesture type is determined. The first mistouch parameter includes at least one of the following: a first preset pressing duration range, a first preset pressing area range, and a first preset pressing time difference. When the pressing duration corresponding to each pressing position is in the first preset pressing duration range, and the pressing area corresponding to each pressing position is in the first preset pressing area range, a pressing time difference between any two pressing positions is determined. When the pressing time difference is greater than or equal to the first preset pressing time difference, it is determined that the target gesture meets the preset gesture.

The preset pressing range, the first preset pressing duration range, the first preset pressing area range, and/or the first preset pressing time difference may all be set by the user himself or by the system default, which are not limited here. The preset pressing range may be a fixed position area of the display screen.

The first preset pressing time range may be in a range from 500 ms to 1 s. The maximum value of the preset pressing time range may be set as the time required to unroll the rollable screen. The minimum value in the first preset pressing area range may be set as the size of the area corresponding to the pressing area of the finger pressing the display screen when the display screen recognizes the minimum pressure value of the thumb pressing the display screen. The maximum value in the first preset pressing area range may be set as the size of the area corresponding to the pressing area of the finger pressing the display screen when the display screen can withstand the maximum pressure value. The specific setting method is not limited here.

The preset pressing time difference may be configured to determine that the multiple pressing positions are pressed simultaneously. In some embodiment, when the time difference between the first pressing position and the second pressing position exceeds 0.3 seconds, it is determined that the multiple pressing positions are not pressed simultaneously, and it is determined that the user has accidentally touched the display screen.

The electronic device may preset the mapping relationship between the finger gesture type and the mistouch parameter. Different mistouch parameters can be preset according to different finger gesture types. The validity of the target gesture can be further determined according to the mistouch parameters, or the target gesture being a user accidental touch can be determined.

In some embodiments, when the multiple pressing positions are not in the preset pressing range, or when the pressing duration corresponding to each pressing position is less than the minimum value of the first preset pressing duration range, or when the pressing area corresponding to each pressing position is outside the first preset pressing area range, or when the pressing time difference is less than the first preset pressing time difference, it is determined that the target gesture does not meet the preset gesture, that is, the target gesture is an invalid gesture.

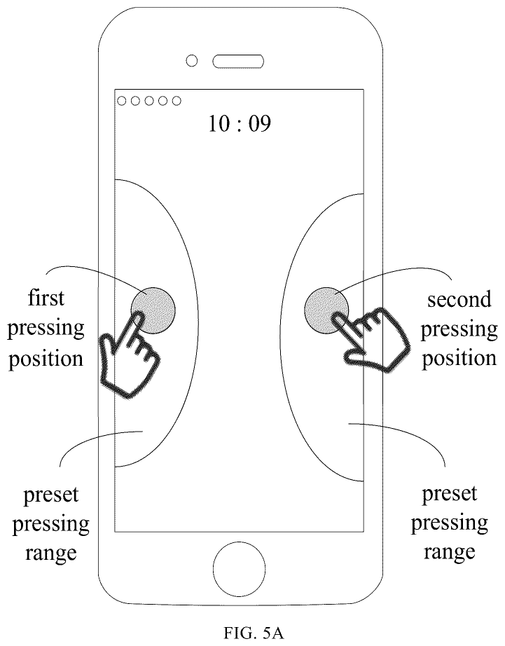

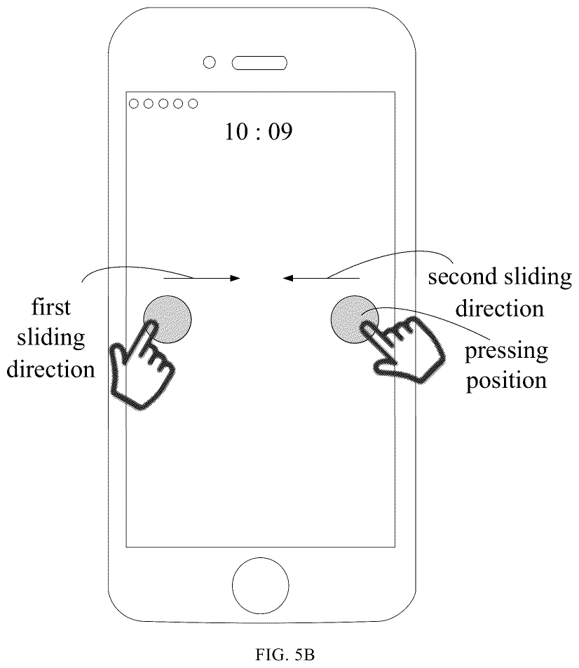

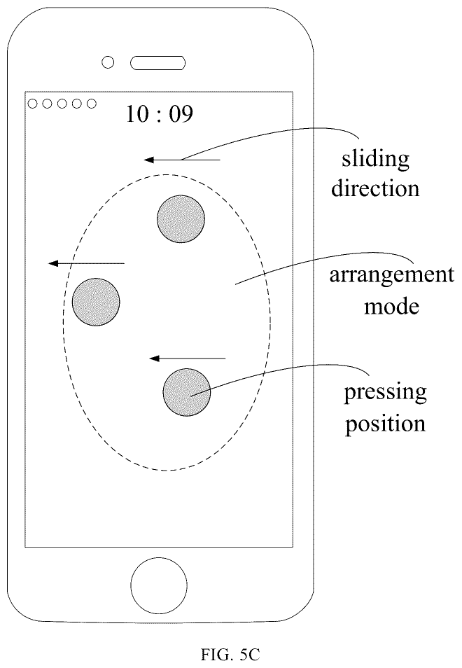

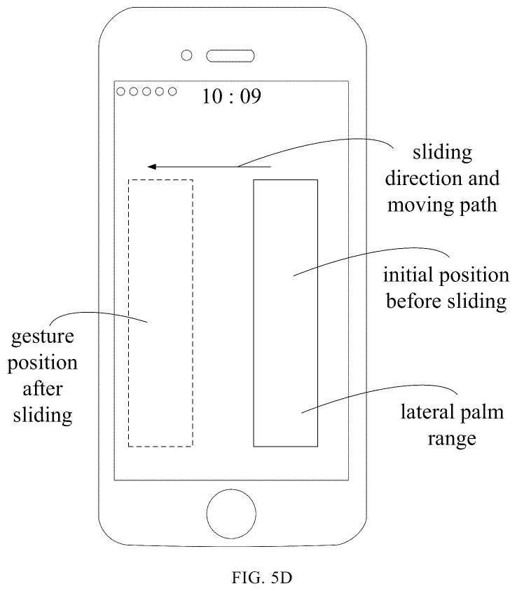

In some embodiments, as illustrated in FIG. 5A, FIG. 5A is a schematic view illustrating interaction between the target gesture and the electronic device. As illustrated in FIG. 5A, the number of the pressing points may be two. The user may use a left thumb and a right thumb to long press in a preset pressing range, and the pressing duration of each pressing position is in the first preset pressing duration range. The pressing time difference between the two pressing positions is greater than the first preset pressing time, and the pressing area corresponding to each pressing position (the first pressing position or the second pressing position) is in the first preset pressing area, it is determined that the target gesture meets the preset gesture, and the rollable screen motor may be started to roll or close the rollable screen through the rollable screen motor. In some embodiments, the preset pressing range on the left may also be double finger, and the pressing range on the right may be single finger. The specific number of the fingers pressing are not limited here.

In some embodiments, the display screen state includes the display state of the first display screen, as illustrated in FIG. 3B; or the display screen state may be the rollable screen unrolled state, as illustrated in FIG. 3A, the rollable screen is in the unrolled state. The user may perform the gesture operation in the preset pressing range specified in the first display screen and/or the second display screen.

Therefore, in the present embodiment, after determining the gesture type, the electronic device may adapt to the gesture type and obtain the mistouch parameter through multi-finger pressing, and further determine that the target gesture meets the preset gesture according to the mistouch parameter. In this way, it is beneficial to quickly locate specific judgment conditions (such as the conditions for the gesture parameters to meet the standard) when determining that the gesture is valid later. It is conducive to reducing the time for the gesture recognition, improving the efficiency of unrolling and/or closing the rollable screen, and saving power consumption.

In some embodiments, the method for determining that the target gesture meets the preset gesture according to the gesture type and/or the gesture parameter may include the following operations: determining the first finger gesture and the second finger gesture included in the target gesture according to the number of the pressing points; determining that the target gesture is the second finger gesture type when the first finger gesture and/or the second finger gesture undergo the sliding displacement; and determining a second mistouch parameter corresponding to the second finger gesture type according to the mapping relationship between the preset finger gesture type and the mistouch parameter. The second mistouch parameter includes at least one of the following: a second preset pressing duration range, a second preset pressing area range, a second preset pressing time difference, a preset sliding direction, and a preset sliding displacement. The first pressing area, the first pressing duration, the first sliding direction, and the first sliding length corresponding to the first finger gesture; and the second pressing area, the second pressing duration, the second sliding direction, and the second sliding length corresponding to the second finger gesture are determined. When the first pressing area and the second pressing area are in the second preset pressing area range, and the first pressing duration and the second pressing duration are in the second preset pressing duration range, the pressing time difference between the first finger gesture and the second finger gesture is determined. When the pressing time difference between the first finger gesture and the second finger gesture is greater than or equal to the second preset pressing time difference, the first sliding direction being consistent with the second sliding direction is determined. When the first sliding direction is consistent with the second sliding direction, and both the first sliding direction and the second sliding direction meet the preset sliding direction, the first sliding length and the second sliding length meeting the preset sliding displacement is determined. When the first sliding length and/or the second sliding length are greater than or equal to the preset sliding displacement, it is determined that the target gesture meets the preset gesture.

In some embodiments, the number of the pressing points, the second preset pressing duration range, the second preset pressing area range, the second preset pressing time difference, the preset sliding direction, and the preset sliding displacement may all be set by the user himself or by the system default, which are not limited here. The second preset pressing duration range, the second preset pressing area range, the second preset pressing time difference, and the preset sliding direction are similar to those in the previous embodiment (as illustrated in FIG. 5A), which are not repeated here.

In some embodiments, only the first finger gesture and the second finger gesture are used for explanation, and the specific finger type (whether it is the same hand, the thumb, or an index finger, etc.) is not limited here.

Different from the embodiments illustrated in FIG. 5A, in some embodiments, the sliding direction and the sliding displacement also need to be considered. The sliding displacement may be described in pixels, and the preset sliding displacement may be the minimum displacement of n pixels that the preset gesture sliding operation is valid. The sliding direction may be set as up, down, left, right, left down, etc., which is not limited here. The sliding direction of the first finger gesture needs to be consistent with the sliding direction of the second finger gesture.

When any one of the first pressing area and the second pressing area is not in the second preset pressing area range, or when any one of the first pressing duration and the second pressing duration is not in the second preset pressing duration range, or when the pressing time difference between the first finger gesture and the second finger gesture is less than the second preset pressing time difference, or when the first sliding direction is inconsistent with the second sliding direction, or when the first sliding length and/or the second sliding length are less than the preset sliding displacement, it is determined that the target gesture does not meet the preset gesture.

In some embodiments, as illustrated in FIG. 5B, FIG. 5B is a schematic view illustrating the interaction between the target gesture and the electronic device. As illustrated in FIG. 5B, the number of the pressing points may be two. The user may press the display screen and slide on the display screen using a left index finger (the first finger gesture) and a middle finger (the second finger gesture), or the left index finger (the first finger gesture) and a right index finger (the second finger gesture), etc. The specific operating fingers are not limited here. When the first pressing area and the second pressing area are in the second preset pressing area range, the first pressing duration and the second pressing duration are in the second preset pressing duration range, the pressing time difference between the first finger gesture and the second finger gesture is less than the second preset pressing time difference, the first sliding direction is consistent with the second sliding direction, and the first sliding length and/or the second sliding length are greater than or equal to the preset sliding displacement, it is determined that the target gesture meets the preset gesture. And accordingly, the rollable screen motor may be started, so as to unroll or close the rollable screen through the rollable screen motor.

The display screen state includes the display state of the first display screen, as illustrated in FIG. 3B; or the display screen state may be the rollable screen unrolled state, as illustrated in FIG. 3A, the rollable screen is in the unrolled state. The user may perform the gesture operation at any position on the first display screen and/or the second display screen.

In some embodiments, the rollable screen may be unrolled or closed by pressing and sliding with two fingers. In some embodiments, after determining the gesture type, the electronic device may adapt to obtain the mistouch parameter according to the gesture type, and further determine that the target gesture meets the preset gesture according to the mistouch parameter. In this way, it is beneficial to quickly locate specific judgment conditions (such as the conditions for the gesture parameters to meet the standard) when determining that the gesture is valid later. It is conducive to reducing the time for the gesture recognition, improving the efficiency of unrolling and/or closing the rollable screen, and saving power consumption.

In some embodiments, the method for determining that the target gesture meets the preset gesture according to the gesture type and/or the gesture parameter may include the following operations: when an arrangement mode of multiple pressing positions meets a preset arrangement mode and the target gesture undergoes sliding displacement, it is determined that the target gesture is a third finger gesture type. According to the mapping relationship between the preset finger gesture type and the mistouch parameter, a third mistouch parameter corresponding to the third finger gesture type is determined. The third mistouch parameter includes at least one of the following: third preset number of the pressing points, a third preset sliding shape, a third preset sliding displacement, and a preset angle. When it is detected that during the target gesture operation, the number of multiple pressing points is maintained as the second preset number of the pressing points, an average value of multiple sliding displacements corresponding to the multiple pressing positions is determined. When the average value is greater than the third preset sliding displacement, it is determined that the sliding direction corresponding to each pressing position is consistent. When the sliding direction corresponding to each pressing position is consistent, the sliding shape formed by the multiple pressing positions during the sliding process is determined. When the sliding shape meets the preset sliding shape, the angle between each sliding direction and the display screen is determined. When each of the angles is less than or equal to the preset angle, it is determined that the target gesture meets the preset gesture. When the finger sliding direction indicated by the historical gesture parameter is opposite to the finger sliding direction indicated by the gesture parameter, it is determined that the target gesture meets the preset gesture.

The preset arrangement may be multiple fingers arranged vertically, horizontally, or in a triangular pattern.

The multiple pressing positions may be any position on the display screen.

The third preset number of the pressing points, the third preset sliding shape, the third preset sliding displacement, and the preset angle may be set by the user himself or by the system default, which are not limited here.

The number of the third pressing points may be set to be greater than or equal to 3. The third preset sliding shape may be a shape corresponding to a path formed by multiple fingers corresponding to multiple pressing positions during the sliding process, and the third preset sliding shape may be set as a straight line. The third preset sliding displacement may be different from the second preset sliding displacement. The preset angle may be an angle formed between multiple fingers and the horizontal line during the sliding process, and the preset angle may be set to 30 degrees, which may be the minimum requirement for the angle formed between the target gesture and the display screen. When the angle between any finger and the horizontal line is greater than 30 degrees, such as 45 degrees, it is determined that the target gesture is invalid, that is, the target gesture does not meet the preset gesture.

In the present embodiment, all fingers must complete the gesture. That is, it is detected that during the target gesture operation, the number of the pressing points is maintained as the second preset number of the pressing points.

When the arrangement mode of the multiple pressing positions does not meet the preset arrangement mode, or when the target gesture undergoes sliding displacement, and the average of the multiple sliding displacements corresponding to the multiple pressing positions is less than the third preset sliding displacement, or when the sliding direction of the finger corresponding to any pressing position is inconsistent, or when the sliding shape does not meet the preset sliding shape, or when the angle is less than or equal to the preset angle, it is determined that the target gesture does not meet the preset gesture.

In some embodiments, as illustrated in FIG. 5C, FIG. 5C is a schematic view illustrating the interaction between the target gesture and the electronic device. In some embodiments, the user may perform the sliding operation on the display screen using three fingers of the left hand (the index finger, the middle finger, and a ring finger), or the corresponding three fingers of the right hand, either in contact or hovering. When the arrangement mode formed by the three pressing positions meets the preset arrangement mode and the target gesture undergoes sliding displacement, it is detected that during the three finger sliding operation, the number of the pressing points is maintained as the second preset number of the pressing point, the average of the three sliding displacements corresponding to the three pressing positions is greater than the third preset sliding displacement, the sliding direction corresponding to each pressing position is consistent, the sliding shape meets the triangle shape, and the angle between each sliding direction and the display screen is less than or equal to the preset angle, it is determined that the target gesture meets the preset gesture. And accordingly, the rollable screen motor may be started, so as to unroll or close the rollable screen through the rollable screen motor.

Therefore, in the present embodiment, the user may press the display screen and slide on the display screen with multiple fingers, or the user may touch the display screen by the hovering gesture with multiple fingers. The multiple fingers form a certain angle with the horizontal line. Therefore, after determining the gesture type, the electronic device may adapt to obtain the mistouch parameter according to the gesture type, and further determine that the target gesture meets the preset gesture according to the mistouch parameter. In this way, it is beneficial to quickly locate specific judgment conditions (such as the conditions for the gesture parameters to meet the standard) when determining that the gesture is valid later. It is conducive to reducing the time for the gesture recognition, improving the efficiency of unrolling and/or closing the rollable screen, and saving power consumption.

In some embodiments, when the gesture type of the target gesture is determined to be the palm gesture type, the gesture parameter may include at least one of the following: the palm moving range, the palm moving direction, the moving path formed in the palm moving range, the angle formed between the palm and the horizontal line during moving the palm, and the palm moving distance, etc. The method for determining that the target gesture meets the preset gesture according to the gesture type and/or the gesture parameter may include the following operations: determining a palm mistouch parameter corresponding to the palm gesture type, wherein the palm mistouch parameter includes at least one of the following: a preset palm moving range, a preset moving path, the preset angle, and a preset palm moving distance; when the palm moving range is in the preset palm moving range, the moving path meets the preset moving path, the angle is less than the preset angle, and the palm moving distance is greater than or equal to the preset palm moving distance, it is determined that the target gesture meets the preset gesture.

The preset palm moving range, the preset moving path, the preset angle, and the preset palm moving distance may be set by the user himself or by the system default, which are not limited here.

The preset palm moving range may be a moving range of the palm when the palm slides horizontally or vertically on the display screen. The preset angle may be an angle formed between the palm and the horizontal line during the sliding process, and the preset angle may be set to 30 degrees, which may be the minimum requirement for the angle formed between the target gesture and the display screen. When the angle between any finger and the horizontal line is greater than 30 degrees, such as 45 degrees, it is determined that the target gesture is invalid, that is, the target gesture does not meet the preset gesture. The preset palm moving distance may be the minimum distance for sliding horizontally or vertically on the display screen, which may be described by the range corresponding to the pixel points.

When the palm moving range is not in the preset palm moving range, or the moving path does not meet the preset moving path (such as, not being the straight line), or the angle is greater than or equal to the preset angle, or the palm moving distance is less than the preset palm moving distance, it is determined that the target gesture does not meet the preset gesture.

In some embodiments, as illustrated in FIG. 5D, FIG. 5D is a schematic view illustrating the interaction between the target gesture and the electronic device. The user may perform the sliding operation on the display screen using the lateral palm of the right hand, either in contact or hovering. When the palm moving range is in the preset palm moving range, the moving path meets the preset moving path, the angle is less than the preset angle, and the palm moving distance is greater than or equal to the preset palm moving distance, it is determined that the target gesture meets the preset gesture. And according, the rollable screen motor may be started, so as to unroll or close the rollable screen through the rollable screen motor.

Therefore, in the present embodiment, after determining the gesture type, the electronic device may adapt to obtain the mistouch parameter according to the gesture type, and further determine that the target gesture meets the preset gesture according to the mistouch parameter. In this way, it is beneficial to quickly locate specific judgment conditions (such as the conditions for the gesture parameters to meet the standard) when determining that the gesture is valid later. It is conducive to reducing the time for the gesture recognition, improving the efficiency of unrolling and/or closing the rollable screen, and saving power consumption.

In some embodiments, the method for determining the motion parameter of the rollable screen motor according to the target gesture may include the following operations: determining that the motion parameter is configured to indicate that the rollable screen is unroll to the first preset state when the target gesture is a first-time operation.

In some embodiments, the method for determining the motion parameter of the rollable screen motor according to the target gesture may include the following operations: determining that the motion parameter is configured to indicate that the rollable screen is closed to the second preset state when the target gesture is not the first-time operation and the rollable screen is in the first preset state; or, determining that the motion parameter is configured to indicate that the rollable screen is closed to the first preset state when the target gesture is not the first-time operation and the rollable screen is in the second preset state.

Therefore, in the present embodiment, the electronic device may determine that the rollable screen is unrolled or closed by judging whether the target gesture is the first-time operation or not the first-time operation, and the current state of the rollable screen. In this case, there is no need to consider the gesture type used by the user last time. There is no need to keep two operations as one unrolling and closing operation. In some embodiments, when the rollable screen was closed by pressing with two fingers last time, the rollable screen may be unrolled by hovering operating with the palm this time, which is beneficial for adapting to various scenarios of unrolling/closing the rollable screen and improving the user experience.

In some embodiments, before determining that the target gesture meets the preset gesture, the method may further include the following operations: obtaining a historical gesture parameter, wherein the historical gesture parameter is the gesture parameter of unrolling or closing the rollable screen last time; and determining that the target gesture meets the preset gesture when the finger sliding direction indicated by the historical gesture parameter is opposite to the finger sliding direction indicated by the gesture parameter.

Corresponding to the embodiment illustrated in FIG. 5C, in a single operation to unroll and close the rollable screen, the moving directions of the target gesture executed twice need to be opposite. In some embodiments, when the rollable screen was unrolled by sliding three fingers to the left during performing the rollable screen operation last time, the rollable screen needs to be closed by sliding to the right this time.

In some embodiments, when the same target gesture is used to achieve the unrolling and/or closing operation of the rollable screen, the moving directions must be opposite during a single unrolling and closing the rollable screen, but it is not limited that the rollable screen must be unrolled to the left or to the right. In this way, when the user forgets the moving direction, it is determined that the preset gesture is met by comparing the two target gestures.

In some embodiments, before determining that the target gesture meets the preset gesture, the method may further include the following operations: obtaining the historical gesture parameter, wherein the historical gesture parameter is the gesture parameter of unrolling or closing the rollable screen last time; and determining that the target gesture meets the preset gesture when the palm moving direction indicated by the historical gesture parameter is opposite to the palm moving direction indicated by the gesture parameter.

Corresponding to the embodiment illustrated in FIG. 5D, in a single operation to unroll and close the rollable screen, the moving directions of the target gesture executed twice need to be opposite. In some embodiments, when the rollable screen was unrolled by sliding the lateral palm to the left during performing the rollable screen operation last time, the rollable screen needs to be closed by sliding the lateral palm to the right this time.

In some embodiments, when the same target gesture is used to achieve the unrolling and/or closing operation of the rollable screen, the moving directions must be opposite during a single unrolling and closing the rollable screen, but it is not limited that the rollable screen must be unrolled to the left or to the right. In this way, when the user forgets the moving direction, it is determined that the preset gesture is met by comparing the two target gestures.

In some embodiments, the method for determining the motion parameter of the rollable screen motor according to the target gesture may include the following operations: in a single operation to unroll and/or close the rollable screen with the finger gesture type or the palm gesture type, when the historical gesture parameter indicates that the rollable screen was in the first preset state last time, determining the motion parameter of the rollable screen motor after determining that the target gesture meets the preset gesture, wherein the motion parameter is configured to indicate that the rollable screen is closed to the second preset state; or, when the historical gesture parameter indicates that the rollable screen was in the second preset state last time, determining the motion parameter of the rollable screen motor after determining that the target gesture meets the preset gesture, wherein the motion parameter is configured to indicate that the rollable screen is unrolled to the first preset state.

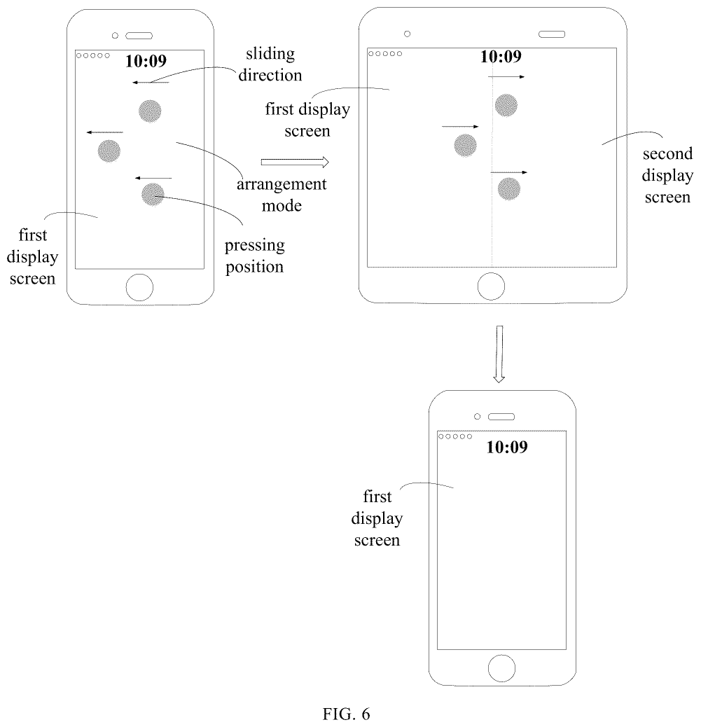

In some embodiments, as illustrated in FIG. 6, when the target gesture is the third finger gesture type and meets the preset gesture, the user may unroll the second display screen, i.e., the rollable screen, by sliding the three fingers to the left. When it is necessary to close the rollable screen, the second display screen, i.e., the rollable screen, needs to be closed by sliding the three fingers to the right.

Therefore, in the present embodiment, when keeping the operation to unroll and close the rollable screen as one unrolling and closing operation of the same gesture type, the desired state of the rollable screen for this time may be determined by the preset state of the rollable screen last time, i.e., the first preset state and/or the second preset state. In this way, when the user forgets the moving direction, it is determined that the preset gesture is met by comparing the two target gestures. It is beneficial for adapting to different scenarios, facilitating diversified gesture recognition to unroll and close the rollable screen, and improving the user experience.

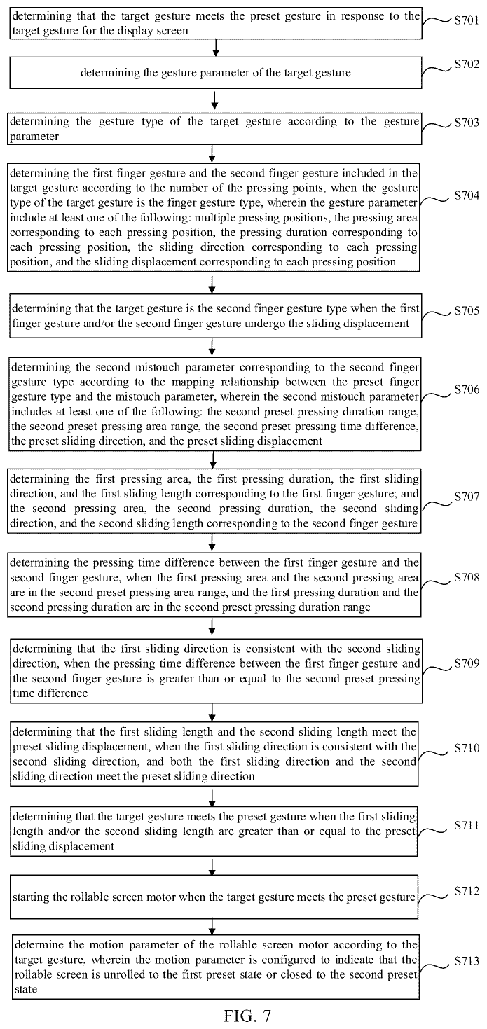

As illustrated in FIG. 7, FIG. 7 is a flowchart illustrating a method for unrolling and rolling the rollable screen in some embodiments of the present disclosure, which is applied to the electronic device. As illustrated in FIG. 7, the method for unrolling and rolling the rollable screen includes the following operations.

At block S701, the method may include determining that the target gesture meets the preset gesture in response to the target gesture for the display screen.

At block S702, the method may include determining the gesture parameter of the target gesture.

At block S703, the method may include determining the gesture type of the target gesture according to the gesture parameter.

At block S704, the method may include determining the first finger gesture and the second finger gesture included in the target gesture according to the number of the pressing points, when the gesture type of the target gesture is the finger gesture type, wherein the gesture parameter include at least one of the following: multiple pressing positions, the pressing area corresponding to each pressing position, the pressing duration corresponding to each pressing position, the sliding direction corresponding to each pressing position, and the sliding displacement corresponding to each pressing position.

At block S705, the method may include determining that the target gesture is the second finger gesture type when the first finger gesture and/or the second finger gesture undergo the sliding displacement.

At block S706, the method may include determining the second mistouch parameter corresponding to the second finger gesture type according to the mapping relationship between the preset finger gesture type and the mistouch parameter, wherein the second mistouch parameter includes at least one of the following: the second preset pressing duration range, the second preset pressing area range, the second preset pressing time difference, the preset sliding direction, and the preset sliding displacement.

At block S707, the method may include determining the first pressing area, the first pressing duration, the first sliding direction, and the first sliding length corresponding to the first finger gesture; and the second pressing area, the second pressing duration, the second sliding direction, and the second sliding length corresponding to the second finger gesture.

At block S708, the method may include determining the pressing time difference between the first finger gesture and the second finger gesture, when the first pressing area and the second pressing area are in the second preset pressing area range, and the first pressing duration and the second pressing duration are in the second preset pressing duration range.

At block S709, the method may include determining that the first sliding direction is consistent with the second sliding direction, when the pressing time difference between the first finger gesture and the second finger gesture is greater than or equal to the second preset pressing time difference.

At block S710, the method may include determining that the first sliding length and the second sliding length meet the preset sliding displacement, when the first sliding direction is consistent with the second sliding direction, and both the first sliding direction and the second sliding direction meet the preset sliding direction.

At block S711, the method may include determining that the target gesture meets the preset gesture when the first sliding length and/or the second sliding length are greater than or equal to the preset sliding displacement.

At block S712, the method may include starting the rollable screen motor when the target gesture meets the preset gesture.

At block S713, the method may include determine the motion parameter of the rollable screen motor according to the target gesture, wherein the motion parameter is configured to indicate that the rollable screen is unrolled to the first preset state or closed to the second preset state.

In some embodiments, the specific description of the operations 701-713 may refer to the corresponding operations 401-403 of the method for unrolling and rolling the rollable screen described in FIG. 4, which are not repeated here.

In the method for unrolling and rolling the rollable screen in the embodiments of the present disclosure, in respond to the target gesture for the display screen, it is determined that the target gesture meets the preset gesture; the gesture parameter of the target gesture is determined; and the gesture type of the target gesture is determined according to the gesture parameter. When the gesture type of the target gesture is the finger gesture type, the gesture parameter includes at least one of the following: multiple pressing positions, the pressing area corresponding to each pressing position, the pressing duration corresponding to each pressing position, the sliding direction corresponding to each pressing position, and the sliding displacement corresponding to each pressing position. According to the number of the pressing points, the first finger gesture and the second finger gesture included in the target gesture are determined. When the first finger gesture and/or the second finger gesture undergo the sliding displacement, it is determined that the target gesture is the second finger gesture type. According to the mapping relationship between the preset finger gesture type and the mistouch parameter, the second mistouch parameter corresponding to the second finger gesture type is determined. The second mistouch parameter includes at least one of the following: the second preset pressing duration range, the second preset pressing area range, the second preset pressing time difference, the preset sliding direction, and the preset sliding displacement. The first pressing area, the first pressing duration, the first sliding direction, and the first sliding length corresponding to the first finger gesture; and the second pressing area, the second pressing duration, the second sliding direction, and the second sliding length corresponding to the second finger gesture are determined. When the first pressing area and the second pressing area are in the second preset pressing area range, and the first pressing duration and the second pressing duration are in the second preset pressing duration range, the pressing time difference between the first finger gesture and the second finger gesture is determined. When the pressing time difference between the first finger gesture and the second finger gesture is greater than or equal to the second preset pressing time difference, it is determined that the first sliding direction is consistent with the second sliding direction. When the first sliding direction is consistent with the second sliding direction and both meet the preset sliding direction, it is determined that the first sliding length and the second sliding length meet the preset sliding displacement. When the first sliding length and/or the second sliding length are greater than or equal to the preset sliding displacement, it is determined that the target gesture meets the preset gesture. When the target gesture meets the preset gesture, the rollable screen motor is started. The motion parameter of the rollable screen motor is determined according to the target gesture. The motion parameter is configured to indicate that the rollable screen is unrolled to the first preset state or closed to the second preset state. In this way, the control of the rollable screen motor may be achieved through the finger gesture, so as to start the rollable screen, which is beneficial for improving the user experience.

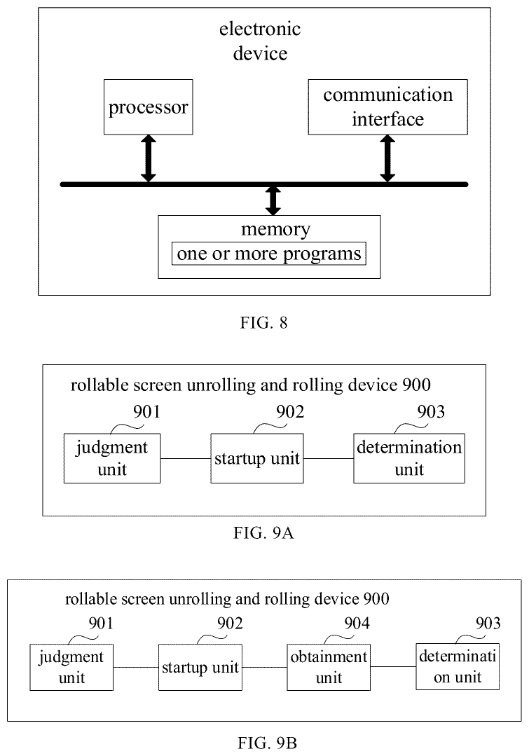

As illustrated in FIG. 8, FIG. 8 is a structural schematic view of an electronic device in some embodiments of the present disclosure. As illustrated in FIG. 8, the electronic device includes a processor, a memory, a communication interface, and one or more programs, which are applied to the electronic device. The one or more programs are stored in the memory and configured to be executed by the processor, so as to execute instructions for the following operations:
starting the rollable screen motor in a case where the target gesture for the display screen meets the preset gesture; and
determining the motion parameter of the rollable screen motor according to the target gesture, wherein the motion parameter is configured to indicate that the rollable screen is unrolled to the first preset state or closes to the second preset state.

In the electronic device described in the embodiments of the present disclosure, it is determined that the target gesture meets the preset gesture in response to the target gesture for the display screen. The rollable screen motor is started when the target gesture meets the preset gesture. The motion parameter of the rollable screen motor is determined according to the target gesture, and the motion parameter is configured to indicate that the rollable screen is unrolled to the first preset state or closes to the second preset state. In this way, the control of the rollable screen motor may be achieved through the gesture, so as to start the rollable screen, which is beneficial for improving the user experience.

In some embodiments, when determining that the target gesture meets the preset gesture, the program further includes instructions for executing the following operations:
determining the gesture parameter of the target gesture;
determining the gesture type of the target gesture according to the gesture parameter; and
determining that the target gesture meets the preset gesture according to the gesture type and/or the gesture parameters.

In some embodiments, when the gesture parameter includes: number of the pressing points and the pressing area. When determining the gesture type of the target gesture according to the gesture parameter, the program includes instructions for executing the following operations:
determining that the gesture type of the target gesture is the finger gesture type, when the number of the pressing points is greater than the first preset number of the pressing points and less than the second preset number of the pressing points; and
determining the gesture type of the target gesture is the palm gesture type, when the number of the pressing points is less than the first preset number of the pressing points, or when the number of the pressing points is greater than or equal to the second preset number of the pressing points, and the pressing area is greater than the preset pressing area.

In some embodiments, when the gesture type of the target gesture is the finger gesture type, the gesture parameter includes at least one of the following: multiple pressing positions, the pressing area corresponding to each pressing position, the pressing duration corresponding to each pressing position, the sliding direction corresponding to each pressing position, and the sliding displacement corresponding to each pressing position.

When determining that the target gesture meets the preset gesture according to the gesture type and/or the gesture parameter, the program includes instructions for executing the following operations:
determining the target gesture is the first finger gesture type when the multiple pressing positions are all in the preset pressing range and it is determined that the target gesture has not undergone sliding displacement;
determining the first mistouch parameter corresponding to the first finger gesture type according to the mapping relationship between the preset finger gesture type and the mistouch parameter, wherein the first mistouch parameter includes at least one of the following: the first preset pressing duration range, a first preset pressing area range, and a first preset pressing time difference;
determining the pressing time difference between any two pressing positions, when the pressing duration corresponding to each pressing position is in the first preset pressing duration range, and the pressing area corresponding to each pressing position is in the first preset pressing area range; and
determining that the target gesture meets the preset gesture when the pressing time difference is greater than or equal to the first preset pressing time difference.

In some embodiments, when determining that the target gesture meets the preset gesture according to the gesture type and/or the gesture parameter, the program includes instructions for executing the following operations:
determining the first finger gesture and the second finger gesture included in the target gesture according to the number of the pressing points;
determining that the target gesture is the second finger gesture type when the first finger gesture and/or the second finger gesture undergo the sliding displacement;
determining the second mistouch parameter corresponding to the second finger gesture type according to the mapping relationship between the preset finger gesture type and the mistouch parameter, wherein the second mistouch parameter includes at least one of the following: the second preset pressing duration range, the second preset pressing area range, the second preset pressing time difference, the preset sliding direction, and the preset sliding displacement;
determining the first pressing area, the first pressing duration, the first sliding direction, and the first sliding length corresponding to the first finger gesture; and the second pressing area, the second pressing duration, the second sliding direction, and the second sliding length corresponding to the second finger gesture;
determining the pressing time difference between the first finger gesture and the second finger gesture, when the first pressing area and the second pressing area are in the second preset pressing area range, and the first pressing duration and the second pressing duration are in the second preset pressing duration range;
determining that the first sliding direction is consistent with the second sliding direction when the pressing time difference between the first finger gesture and the second finger gesture is greater than or equal to the second preset pressing time difference;
determining that the first sliding length and the second sliding length meet the preset sliding displacement when the first sliding direction is consistent with the second sliding direction and both meet the preset sliding direction; and
determining that the target gesture meets the preset gesture when the first sliding length and/or the second sliding length are greater than or equal to the preset sliding displacement.

In some embodiments, when determining that the target gesture meets the preset gesture according to the gesture type and/or the gesture parameter, the program includes instructions for executing the following operations:
determining that the target gesture is the third finger gesture type when the arrangement mode of multiple pressing positions meets the preset arrangement mode and the target gesture undergoes sliding displacement;
determining the third mistouch parameter corresponding to the third finger gesture type according to the mapping relationship between the preset finger gesture type and the mistouch parameter, wherein the third mistouch parameter includes at least one of the following: the third preset number of the pressing points, the third preset sliding shape, the third preset sliding displacement, and the preset angle;
determining the average value of multiple sliding displacements corresponding to the multiple pressing positions when it is detected that the number of multiple pressing points is maintained as the second preset number of the pressing points during the target gesture operation;
determining that the sliding direction corresponding to each pressing position is consistent when the average value is greater than the third preset sliding displacement;
determining the sliding shape formed by the multiple pressing positions during the sliding process when the sliding direction corresponding to each pressing position is consistent;
determining the angle between each sliding direction and the display screen when the sliding shape meets the preset sliding shape; and
determining that the target gesture meets the preset gesture when each of the angles is less than or equal to the preset angle.

In some embodiments, when the gesture type of the target gesture is determined to be the palm gesture type, the gesture parameter includes at least one of the following: the palm moving range, the palm moving direction, the moving path formed in the palm moving range, the angle formed between the palm and the horizontal line during movement, and the palm moving distance.

When determining that the target gesture meets the preset gesture according to the gesture type and/or the gesture parameter, the program includes instructions for executing the following operations:
determining the palm mistouch parameter corresponding to the palm gesture type, wherein the palm mistouch parameter includes at least one of the following: the preset palm moving range, the preset moving path, the preset angle, and the preset palm moving distance; and
determining that the target gesture meets the preset gesture, when the palm moving range is in the preset palm moving range, the moving path meets the preset moving path, the angle is less than the preset angle, and the palm moving distance is greater than or equal to the preset palm moving distance.

In some embodiments, when determining the motion parameter of the rollable screen motor according to the target gesture, the program includes instructions for executing the following operations:
determining that the motion parameter is configured to indicate that the rollable screen is unrolled to the first preset state when the target gesture is the first-time operation.

In some embodiments, when determining the motion parameter of the rollable screen motor according to the target gesture, the program includes instructions for executing the following operations:
determining that the motion parameter in configured to indicate that the rollable screen is closed to the second preset state when the target gesture is not the first-time operation and the rollable screen is in the first preset state; or
determining that the motion parameter is configured to indicate that the rollable screen is closed to the first preset state when the target gesture is not the first-time operation and the rollable screen is in the second preset state.

In some embodiments, before determining that the target gesture meets the preset gesture, the program further includes instructions for executing the following operations:
obtaining the historical gesture parameter, wherein the historical gesture parameter is the gesture parameter of unrolling or closing the rollable screen last time; and
determining that the target gesture meets the preset gesture when the finger sliding direction indicated by the historical gesture parameter is opposite to the finger sliding direction indicated by the gesture parameter.

In some embodiments, before determining that the target gesture meets the preset gesture, the program further includes instructions for executing the following operations:
obtaining the historical gesture parameter, wherein the historical gesture parameter is the gesture parameter of unrolling or closing the rollable screen last time; and
determining that the target gesture meets the preset gesture when the palm moving direction indicated by the historical gesture parameter is opposite to the palm moving direction indicated by the gesture parameter.

In some embodiments, when determining the motion parameter of the rollable screen motor according to the target gesture, the program includes instructions for executing the following operations:
in a single operation to unroll and/or close the rollable screen with the finger gesture type or the palm gesture type, when the historical gesture parameter indicates that the rollable screen was in the first preset state last time, determining the motion parameter of the rollable screen motor after determining that the target gesture meets the preset gesture, wherein the motion parameter is configured to indicate that the rollable screen is closed to the second preset state; or
when the historical gesture parameter indicates that the rollable screen was in the second preset state last time, determining the motion parameter of the rollable screen motor after determining that the target gesture meets the preset gesture, wherein the motion parameter is configured to indicate that the rollable screen is unrolled to the first preset state.

The above description mainly introduces the solutions in the embodiments of the present disclosure from the perspective of the method side execution process. The electronic device includes hardware structures and/or software modules corresponding to the execution of various functions, so as to achieve the above functions. Those of ordinary skill in the art should easily realize that the present disclosure may be implemented in the form of hardware or a combination of the hardware and computer software, in combination with the units and algorithm steps described in the embodiments of the present disclosure. Whether a function is achieved by the hardware or in a way that the computer software drives the hardware depends on the specific application and design constraint conditions of the technical solution. Those of ordinary skill in the art may use different methods for each specific application to achieve the described functions, but such implementation should not be considered beyond the scope of the present disclosure.

In the embodiments of the present disclosure, the electronic device may be divided into functional units according to the above method embodiments. For example, each functional unit is divided according to each function, or two or more functions may be integrated into one processing unit. The integrated unit may be implemented in a form of hardware, or may be implemented in a form of a software functional unit. It should be noted that the division of the units in the embodiments of the present disclosure is illustrative and only a logical functional division. In actual implementation, there may be another division mode.

In the case of dividing each functional module according to each function, FIG. 9A shows a schematic view of a rollable screen unrolling and rolling device. As illustrated in FIG. 9A, the rollable screen unrolling and rolling device is applied to the electronic device. The rollable screen unrolling and rolling device 900 may include a judgment unit 901, a startup unit 902, and a determination unit 903.

The judgment unit 901 is configured to determine that the target gesture meets the preset gesture in response to the target gesture for the display screen.

The startup unit 902 is configured to start the rollable screen motor when the target gesture meets the preset gesture.

The determination unit 903 is configured to determine the motion parameter of the rollable screen motor according to the target gesture, wherein the motion parameter is configured to indicate that the rollable screen is unrolled to the first preset state or closed to the second preset state.

Therefore, in the rollable screen unrolling and rolling device in the embodiments of the present disclosure, it is determined that the target gesture meets the preset gesture in response to the target gesture for the display screen. The rollable screen motor is started when the target gesture meets the preset gesture. The motion parameter of the rollable screen motor is determined according to the target gesture, and the motion parameter is configured to indicate that the rollable screen is unrolled to the first preset state or closed to the second preset state. In this way, the control of the rollable screen motor may be achieved through the gesture, so as to start the rollable screen, which is beneficial for improving the user experience.

In some embodiments, when determining that the target gesture meets the preset gesture, the judgment unit 901 is configured for:
determining the gesture parameter of the target gesture;
determining the gesture type of the target gesture according to the gesture parameter; and
determining that the target gesture meets the preset gesture according to the gesture type and/or the gesture parameter.

In some embodiments, the gesture parameter include: number of the pressing points and the pressing area; when determining the gesture type of the target gesture according to the gesture parameters, the determination unit 903 is further configured for:
determining that the gesture type of the target gesture is the finger gesture type when the number of the pressing points is greater than the first preset number of the pressing points and less than the second preset number of the pressing points; and
determining that the gesture type of the target gesture is the palm gesture type, when the number of the pressing points is less than the first preset number of the pressing points, or when the number of the pressing points is greater than or equal to the second preset number of the pressing points, and the pressing area is greater than the preset pressing area.

In some embodiments, when the gesture type of the target gesture is the finger gesture type, the gesture parameter includes at least one of the following: multiple pressing positions, the pressing area corresponding to each pressing position, the pressing duration corresponding to each pressing position, the sliding direction corresponding to each pressing position, and the sliding displacement corresponding to each pressing position.

When determining that the target gesture meets the preset gesture according to the gesture type and/or the gesture parameter, the judgment unit 901 is configured for:
determining the target gesture is the first finger gesture type when the multiple pressing positions are all in the preset pressing range and it is determined that the target gesture has not undergone sliding displacement;
determining the first mistouch parameter corresponding to the first finger gesture type according to the mapping relationship between the preset finger gesture type and the mistouch parameter, wherein the first mistouch parameter includes at least one of the following: the first preset pressing duration range, the first preset pressing area range, and the first preset pressing time difference;
determining the pressing time difference between any two pressing positions when the pressing duration corresponding to each pressing position is in the first preset pressing duration range, and the pressing area corresponding to each pressing position is in the first preset pressing area range; and
determining that the target gesture meets the preset gesture when the pressing time difference is greater than or equal to the first preset pressing time difference.

In some embodiments, when determining that the target gesture meets the preset gesture according to the gesture type and/or the gesture parameter, the judgment unit 901 is configured for:
determining the first finger gesture and the second finger gesture included in the target gesture according to the number of the pressing points;
determining that the target gesture is the second finger gesture type when the first finger gesture and/or the second finger gesture undergo the sliding displacement;
determining the second mistouch parameter corresponding to the second finger gesture type according to the mapping relationship between the preset finger gesture type and the mistouch parameter, wherein the second mistouch parameter includes at least one of the following: the second preset pressing duration range, the second preset pressing area range, the second preset pressing time difference, the preset sliding direction, and the preset sliding displacement;
determining the first pressing area, the first pressing duration, the first sliding direction, and the first sliding length corresponding to the first finger gesture; and the second pressing area, the second pressing duration, the second sliding direction, and the second sliding length corresponding to the second finger gesture;
determining the pressing time difference between the first finger gesture and the second finger gesture when the first pressing area and the second pressing area are in the second preset pressing area range, and the first pressing duration and the second pressing duration are in the second preset pressing duration range;
determining that the first sliding direction is consistent with the second sliding direction when the pressing time difference between the first finger gesture and the second finger gesture is greater than or equal to the second preset pressing time difference;
determining that the first sliding length and the second sliding length meet the preset sliding displacement when the first sliding direction is consistent with the second sliding direction and both meet the preset sliding direction; and
determining that the target gesture meets the preset gesture when the first sliding length and/or the second sliding length are greater than or equal to the preset sliding displacement.

In some embodiments, when determining that the target gesture meets the preset gesture according to the gesture type and/or the gesture parameter, the judgment unit 901 is configured for:
determining that the target gesture is the third finger gesture type when the arrangement mode of multiple pressing positions meets the preset arrangement mode and the target gesture undergoes sliding displacement;
determining the third mistouch parameter corresponding to the third finger gesture type according to the mapping relationship between the preset finger gesture type and the mistouch parameter, wherein the third mistouch parameter includes at least one of the following: the third preset number of the pressing points, the third preset sliding shape, the third preset sliding displacement, and the preset angle;
determining the average value of multiple sliding displacements corresponding to the multiple pressing positions when it is detected that during the target gesture operation, the number of multiple pressing points is maintained as the second preset number of the pressing points;
determining that the sliding direction corresponding to each pressing position is consistent when the average value is greater than the third preset sliding displacement;
determining the sliding shape formed by the multiple pressing positions during the sliding process when the sliding direction corresponding to each pressing position is consistent;
determining the angle between each sliding direction and the display screen when the sliding shape meets the preset sliding shape; and
determining that the target gesture meets the preset gesture when each of the angles is less than or equal to the preset angle.

In some embodiments, when the gesture type of the target gesture is determined to be the palm gesture type, the gesture parameter include at least one of the following: the palm moving range, the palm moving direction, the moving path formed in the palm moving range, the angle formed between the palm and the horizontal line during movement, and the palm moving distance.

When determining that the target gesture meets the preset gesture according to the gesture type and/or the gesture parameter, the judgment unit 901 is configured for:
determining the palm mistouch parameter corresponding to the palm gesture type, wherein the palm mistouch parameter includes at least one of the following: the preset palm moving range, the preset moving path, the preset angle, and the preset palm moving distance; and
determining that the target gesture meets the preset gesture when the palm moving range is in the preset palm moving range, the moving path meets the preset moving path, the angle is less than the preset angle, and the palm moving distance is greater than or equal to the preset palm moving distance.

In some embodiments, when determining the motion parameter of the rollable screen motor according to the target gesture, the determination unit 903 is configured for:
determining that the motion parameter is configured to indicate that the rollable screen is unrolled to the first preset state when the target gesture is the first-time operation.

In some embodiments, when determining the motion parameter of the rollable screen motor according to the target gesture, the determination unit 903 is configured for:
determining that the motion parameter is configured to indicate that the rollable screen is closed to the second preset state when the target gesture is not the first-time operation and the rollable screen is in the first preset state; or
determining that the motion parameter is configured to indicate that the rollable screen is closed to the first preset state when the target gesture is not the first-time operation and the rollable screen is in the second preset state.

In some embodiments, before determining that the target gesture meets the preset gesture, as illustrated in FIG. 9B, which is consistent with FIG. 9A, FIG. 9B is a schematic view of the rollable screen unrolling and rolling device. The rollable screen unrolling and rolling device 900 may further include an obtainment unit 904 for obtaining the historical gesture parameter, and the historical gesture parameter is the gesture parameter of unrolling and closing the rollable screen last time.

In some embodiments, after obtaining the historical gesture parameter, the determination unit 903 is also configured for:
determining that the target gesture meets the preset gesture when the finger sliding direction indicated by the historical gesture parameter is opposite to the finger sliding direction indicated by the gesture parameter.

In some embodiments, after obtaining the historical gesture parameter, the determination unit 903 is also configured for:
determining that the target gesture meets the preset gesture when the palm moving direction indicated by the historical gesture parameter is opposite to the palm moving direction indicated by the gesture parameter.

In some embodiments, when determining the motion parameter of the rollable screen motor according to the target gesture, the determination unit 903 is configured for:
in a single operation to unroll and/or close the rollable screen with the finger gesture type or the palm gesture type, when the historical gesture parameter indicates that the rollable screen was in the first preset state last time, determining the motion parameter of the rollable screen motor after determining that the target gesture meets the preset gesture, wherein the motion parameter is configured to indicate that the rollable screen is closed to the second preset state; or
when the historical gesture parameter indicates that the rollable screen was in the second preset state last time, determining the motion parameter of the rollable screen motor after determining that the target gesture meets the preset gesture, wherein the motion parameter is configured to indicate that the rollable screen is unrolled to the first preset state.

All relevant content of the operations involved in the above method embodiments may be referenced to the functional descriptions of the corresponding functional modules, which are not repeated here.

The electronic device provided in the embodiments is configured to execute the above-mentioned method for unrolling and rolling the rollable screen, thereby achieving the same effect as the above-mentioned implementation methods.

In the case of using integrated units, the electronic device may include a processing module, a storage module, and a communication module. The processing module may be configured to control and manage the actions of the electronic device, for example, the processing module may be configured to support the electronic device to perform the operations executed by the judgment unit 901, the startup unit 902, the determination unit 903, and the acquisition unit 904. The storage module may be configured to support the electronic device in executing stored program code and the data, etc. The communication module may be configured to support communication between the electronic device and other devices.

The processing module may be the processor or the controller. The processing module may implement or execute various exemplary logical blocks, modules, and circuits described in conjunction with the disclosed content of the present disclosure. The processor may also be a combination that implements the computing functions, such as a combination of one or more microprocessors, a combination of the digital signal processing (DSP) and the microprocessor, etc. The storage module may be the memory. The communication module may specifically refer to a device that interacts with other electronic devices, such as a RF circuit, a Bluetooth chip, a Wi-Fi chip, etc.

The embodiments of the present disclosure further provide a computer storage medium, and the computer storage medium stores the computer program configured for electronic data interchange. The computer program allows the computer to execute part or all of the operations of any method described in the above method embodiments, and the computer includes the electronic device.

The embodiments of the present disclosure further provide a computer program product, and the computer program product includes a non-transient computer-readable storage medium storing the computer program. The computer program is operable to allow the computer to execute part or all of the operations of any method described in the method embodiments. The computer program product may be a software installation package, and the computer includes the electronic device.

In the embodiments of the present disclosure, the electronic device determines that the target gesture meets the preset gesture in response to the target gesture for the display screen. When the target gesture meets the preset gesture, the rollable screen motor is started. A motion parameter of the rollable screen motor is determined according to the target gesture, and the motion parameter is configured to indicate that the rollable screen is unrolled to a first preset state or is closed to a second preset state. In this way, control of the rollable screen motor can be achieved through diverse gestures, so as to start the rollable screen, which is beneficial for improving user experience.

In order to simplify the description, the above method embodiments are all described as a series of action combinations. However, those of ordinary skill in the art should know that the present disclosure is not limited by the order of the described actions, because certain operations may be performed in other orders or simultaneously according to the present disclosure. Furthermore, those of ordinary skill in the art should also know that the embodiments described in the specification are all preferred embodiments, and the actions and modules involved are not necessarily necessary for the present disclosure.

In the above embodiments, the description of each embodiment has its own emphasis. For parts that are not detailed in an embodiment, reference may be made to related descriptions of other embodiments.

In the embodiments provided by the present disclosure, it should be understood that, the disclosed device may be implemented in other manners. For example, the device embodiments described above are only illustrative. For example, the division of the units is only a logical function division. In actual implementation, other division manners may be possible. For example, a plurality of units or components may be integrated into another system, or some features may be omitted or may not be implemented. In addition, the displayed or discussed mutual coupling, direct coupling or communication connection may be indirect coupling or communication connection through some interfaces, devices or units, and may be in electrical or other forms.

The units described as separation components may be or may not be physically separated. The component used as display unit may be or may not be a physical unit. That is, the units may be located in the same place, or may be distributed to many network units. Some or all of the units may be selected according to actual requirements, so as to implement the solutions of the embodiments.

In addition, the functional units in some embodiments of the present disclosure may be integrated into one processing unit, or each unit may be physically independent, or two or more units may be integrated into one unit. The integrated unit may be implemented in a form of the hardware, or may be implemented in a form of the software functional unit.

When the above integrated units are implemented in the form of the software functional module, and sold or used as an independent product, the integrated units may also be stored in the computer-readable storage medium. Based on such an understanding, the technical solution of the embodiments of the present disclosure essentially or partially contribute to the related art, or all or part of the technical solution may be reflected in the form of a software product. The computer software product is stored in the memory and includes several instructions for enabling a computer device (i.e., a personal computer, a server, or a network device, etc.) to perform all or a part of the methods described in various embodiments of the present disclosure. The aforementioned memory may include various media that may store the program code, such as a USB flash drive, a read only memory (ROM), a random access memory (RAM), a portable hard drive, a magnetic disk, or a compact disc, etc.

Those of ordinary skill in the art may understand that all or part of the operations in the various methods of the above embodiments may be completed by relevant hardware that is instructed by the program. The program may be stored in the computer-readable memory, and the memory may include a flash drive, the read-only memory (ROM), the random access memory (RAM), the magnetic disk or the compact disc, etc.

The embodiments of the present disclosure are described in detail, and specific examples are provided to describe and explain the principles and implementation modes of the present disclosure. The above explanation of the examples is only used to help understand the methods and core ideas of the present disclosure. Furthermore, according to the ideas of the present disclosure, those of ordinary skill in the art may change the specific implementation mode and the application scope. In summary, the contents of the present specification should not be understood as limiting the present disclosure.

What is claimed is:

1. A method for unrolling and rolling a rollable screen, comprising:
starting a rollable screen motor in a case where a target gesture for a display screen meets a preset gesture; and
determining a motion parameter of the rollable screen motor according to the target gesture, wherein the motion parameter is configured to indicate that the rollable screen is unrolled to a first preset state or is closed to a second preset state.

2. The method according to claim 1, wherein the case where the target gesture for the display screen meets the preset gesture, comprises:
determining a gesture parameter of the target gesture;
determining a gesture type of the target gesture according to the gesture parameter; and
determining that the target gesture meets the preset gesture according to the gesture type and/or the gesture parameter.

3. The method according to claim 2, wherein when the gesture parameter comprises the number of pressing points and a pressing area, the determining a gesture type of the target gesture according to the gesture parameter, comprises:
determining that the gesture type of the target gesture is a finger gesture type when the number of the pressing points is greater than a first preset number of the pressing points and less than a second preset number of the pressing points; and
determining that the gesture type of the target gesture is a palm gesture type when the number of the pressing points is less than the first preset number of the pressing points, or when the number of the pressing points is greater than or equal to the second preset number of the pressing points, and the pressing area is greater than a preset pressing area.

4. The method according to claim 3, wherein when the gesture type of the target gesture is the finger gesture type, the gesture parameter comprises at least one of the following: a plurality of pressing positions, the pressing area corresponding to each pressing position, a pressing duration corresponding to each pressing position, a sliding direction corresponding to each pressing position, and a sliding displacement corresponding to each pressing position; and
the determining that the target gesture meets the preset gesture according to the gesture type and/or the gesture parameter, comprises:
determining that the target gesture is a first finger gesture type when the plurality of pressing positions are in a preset pressing range and it is determined that the target gesture has not undergone a sliding displacement;
determining a first mistouch parameter corresponding to the first finger gesture type according to a mapping relationship between a preset finger gesture type and a mistouch parameter, wherein the first mistouch parameter comprises at least one of the following: a first preset pressing duration range, a first preset pressing area range, and a first preset pressing time difference;
determining a pressing time difference between any two pressing positions when the pressing duration corresponding to each pressing position is in the first preset pressing duration range, and the pressing area corresponding to each pressing position is in the first preset pressing area range; and
determining that the target gesture meets the preset gesture when the pressing time difference is greater than or equal to the first preset pressing time difference.

5. The method according to claim 4, wherein the determining that the target gesture meets the preset gesture according to the gesture type and/or the gesture parameter, comprises:
determining a first finger gesture and a second finger gesture comprised in the target gesture according to the number of the pressing points;
determining that the target gesture is the second finger gesture when the first finger gesture and/or the second finger gesture undergo the sliding displacement;
determining a second mistouch parameter corresponding to the second finger gesture type according to the mapping relationship between the preset finger gesture type and the mistouch parameter, wherein the second mistouch parameter comprises at least one of the following: a second preset pressing duration range, a second preset pressing area range, a second preset pressing time difference, a preset sliding direction, and a preset sliding displacement;
determining a first pressing area, a first pressing duration, a first sliding direction, and a first sliding length corresponding to the first finger gesture; and a second pressing area, a second pressing duration, a second sliding direction, and a second sliding length corresponding to the second finger gesture;
determining the pressing time difference between the first finger gesture and the second finger gesture when the first pressing area and the second pressing area are in the second preset pressing area range, and the first pressing duration and the second pressing duration are in the second preset pressing duration range;
determining that the first sliding direction is consistent with the second sliding direction when the pressing time difference between the first finger gesture and the second finger gesture is greater than or equal to the second preset pressing time difference;
determining that the first sliding length and the second sliding length meets the preset sliding displacement when the first sliding direction is consistent with the second sliding direction, and the first sliding direction and the second sliding direction meet the preset sliding direction; and
determining that the target gesture meets the preset gesture when the first sliding length and/or the second sliding length are greater than or equal to the preset sliding displacement.

6. The method according to claim 4, wherein the determining that the target gesture meets the preset gesture according to the gesture type and/or the gesture parameter, comprises:
determining that the target gesture is a third finger gesture type when an arrangement mode formed by the plurality of pressing positions meets a preset arrangement mode and the target gesture undergoes the sliding displacement;
determining a third mistouch parameter corresponding to the third finger gesture type according to the mapping relationship between the preset finger gesture type and the mistouch parameter, wherein the third mistouch parameter comprises at least one of the following: a third preset number of the pressing points, a third preset sliding shape, a third preset sliding displacement, and a first preset angle;
determining an average value of a plurality of sliding displacements corresponding to the plurality of pressing positions when it is detected that during a target gesture operation, the number of a plurality of pressing points is maintained as the second preset number of the pressing points;
determining that the sliding direction corresponding to each pressing position is consistent when the average value is greater than the third preset sliding displacement;
determining the sliding shape formed by the plurality of pressing positions during sliding when the sliding direction corresponding to each pressing position is consistent;
determining an angle between each sliding direction and the display screen when the sliding shape meets the third preset sliding shape; and
determining that the target gesture meets the preset gesture when each of the angles is less than or equal to the first preset angle.

7. The method according to claim 3, wherein when determining the gesture type of the target gesture is a palm gesture type, the gesture parameter comprises at least one of the following: a palm moving range, a palm moving direction, a moving path formed in a palm moving range, an angle formed between a palm and a horizontal line during movement, and a palm moving distance;
the determining that the target gesture meets the preset gesture according to the gesture type and/or the gesture parameter, comprises:
determining a palm mistouch parameter corresponding to the palm gesture type, wherein the palm mistouch parameter comprises at least one of the following: a preset palm moving range, a preset moving path, a second preset angle, and a preset palm moving distance; and
determining that the target gesture meets the preset gesture when the palm moving range is in the preset palm moving range, the moving path meets the preset moving path, the angle is less than the second preset angle, and the palm moving distance is greater than or equal to the preset palm moving distance.

8. The method according to claim 2, wherein the determining a motion parameter of the rollable screen motor according to the target gesture, comprises:
determining that the motion parameter is configured to indicate that the rollable screen is unrolled to the first preset state when the target gesture is a first-time operation.

9. The method according to claim 4, wherein the determining a motion parameter of the rollable screen motor according to the target gesture, comprises:
determining that the motion parameter is configured to indicate that the rollable screen is closed to the second preset state when the target gesture is not a first-time operation and the rollable screen is in the first preset state; or
determining the motion parameter is configured to indicate that the rollable screen is closed to the first preset state when the target gesture is not the first-time operation and the rollable screen is in the second preset state.

10. The method according to claim 6, wherein before determining that the target gesture meets the preset gesture, the method further comprises:
obtaining a historical gesture parameter, wherein the historical gesture parameter is the gesture parameter of unrolling or closing the rollable screen last time; and
determining that the target gesture meets the preset gesture when a finger sliding direction indicated by the historical gesture parameter is opposite to a finger sliding direction indicated by the gesture parameter.

11. The method according to claim 7, wherein before determining that the target gesture meets the preset gesture, the method further comprises:
obtaining a historical gesture parameter, wherein the historical gesture parameter is the gesture parameter of unrolling or closing the rollable screen last time; and
determining that the target gesture meets the preset gesture when the palm moving direction indicated by the historical gesture parameter is opposite to the palm moving direction indicated by the gesture parameter.

12. The method according to claim 10, wherein the determining a motion parameter of the rollable screen motor according to the target gesture, comprises:
in a single operation to unroll and/or close the rollable screen with the finger gesture type or the palm gesture type, determining the motion parameter of the rollable screen motor after determining that the target gesture meets the preset gesture when the historical gesture parameter indicates that the rollable screen was in the first preset state last time, wherein the motion parameter is configured to indicate that the rollable screen is closed to the second preset state; or
determining the motion parameter of the rollable screen motor after determining that the target gesture meets the preset gesture when the historical gesture parameter indicates that the rollable screen was in the second preset state last time, wherein the motion parameter is configured to indicate that the rollable screen is unrolled to the first preset state.

13. An electronic device, comprising:
a processor;
a memory;
a communication interface; and
one or more programs, wherein the one or more programs are stored in the memory and configured to be executed by the processor, the programs comprise instructions for executing operations in a method for unrolling and rolling a rollable screen, and the method comprises:
starting a rollable screen motor in a case where a target gesture for a display screen meets a preset gesture; and
determining a motion parameter of the rollable screen motor according to the target gesture, wherein the motion parameter is configured to indicate that the rollable screen is unrolled to a first preset state or is closed to a second preset state.

14. The electronic device according to claim 13, wherein the case where the target gesture for the display screen meets the preset gesture, comprises:
determining a gesture parameter of the target gesture;
determining a gesture type of the target gesture according to the gesture parameter; and
determining that the target gesture meets the preset gesture according to the gesture type and/or the gesture parameter.

15. The electronic device according to claim 14, wherein when the gesture parameter comprises the number of pressing points and a pressing area, the determining a gesture type of the target gesture according to the gesture parameter, comprises:
determining that the gesture type of the target gesture is a finger gesture type when the number of the pressing points is greater than a first preset number of the pressing points and less than a second preset number of the pressing points; and
determining that the gesture type of the target gesture is a palm gesture type when the number of the pressing points is less than the first preset number of the pressing points, or when the number of the pressing points is greater than or equal to the second preset number of the pressing points, and the pressing area is greater than a preset pressing area.

16. The electronic device according to claim 15, wherein when the gesture type of the target gesture is the finger gesture type, the gesture parameter comprises at least one of the following: a plurality of pressing positions, the pressing area corresponding to each pressing position, a pressing duration corresponding to each pressing position, a sliding direction corresponding to each pressing position, and a sliding displacement corresponding to each pressing position; and
the determining that the target gesture meets the preset gesture according to the gesture type and/or the gesture parameter, comprises:
determining that the target gesture is a first finger gesture type when the plurality of pressing positions are in a preset pressing range and it is determined that the target gesture has not undergone a sliding displacement;
determining a first mistouch parameter corresponding to the first finger gesture type according to a mapping relationship between a preset finger gesture type and a mistouch parameter, wherein the first mistouch parameter comprises at least one of the following: a first preset pressing duration range, a first preset pressing area range, and a first preset pressing time difference;
determining a pressing time difference between any two pressing positions when the pressing duration corresponding to each pressing position is in the first preset pressing duration range, and the pressing area corresponding to each pressing position is in the first preset pressing area range; and
determining that the target gesture meets the preset gesture when the pressing time difference is greater than or equal to the first preset pressing time difference.

17. The electronic device according to claim 16, wherein the determining that the target gesture meets the preset gesture according to the gesture type and/or the gesture parameter, comprises:
determining a first finger gesture and a second finger gesture comprised in the target gesture according to the number of the pressing points;
determining that the target gesture is the second finger gesture when the first finger gesture and/or the second finger gesture undergo the sliding displacement;
determining a second mistouch parameter corresponding to the second finger gesture type according to the mapping relationship between the preset finger gesture type and the mistouch parameter, wherein the second mistouch parameter comprises at least one of the following: a second preset pressing duration range, a second preset pressing area range, a second preset pressing time difference, a preset sliding direction, and a preset sliding displacement;
determining a first pressing area, a first pressing duration, a first sliding direction, and a first sliding length corresponding to the first finger gesture; and a second pressing area, a second pressing duration, a second sliding direction, and a second sliding length corresponding to the second finger gesture;
determining the pressing time difference between the first finger gesture and the second finger gesture when the first pressing area and the second pressing area are in the second preset pressing area range, and the first pressing duration and the second pressing duration are in the second preset pressing duration range;
determining that the first sliding direction is consistent with the second sliding direction when the pressing time difference between the first finger gesture and the second finger gesture is greater than or equal to the second preset pressing time difference;
determining that the first sliding length and the second sliding length meets the preset sliding displacement when the first sliding direction is consistent with the second sliding direction, and the first sliding direction and the second sliding direction meet the preset sliding direction; and
determining that the target gesture meets the preset gesture when the first sliding length and/or the second sliding length are greater than or equal to the preset sliding displacement.

18. The electronic device according to claim 16, wherein the determining that the target gesture meets the preset gesture according to the gesture type and/or the gesture parameter, comprises:
determining that the target gesture is a third finger gesture type when an arrangement mode formed by the plurality of pressing positions meets a preset arrangement mode and the target gesture undergoes the sliding displacement;
determining a third mistouch parameter corresponding to the third finger gesture type according to the mapping relationship between the preset finger gesture type and the mistouch parameter, wherein the third mistouch parameter comprises at least one of the following: a third preset number of the pressing points, a third preset sliding shape, a third preset sliding displacement, and a first preset angle;
determining an average value of a plurality of sliding displacements corresponding to the plurality of pressing positions when it is detected that during a target gesture operation, the number of a plurality of pressing points is maintained as the second preset number of the pressing points;
determining that the sliding direction corresponding to each pressing position is consistent when the average value is greater than the third preset sliding displacement;
determining the sliding shape formed by the plurality of pressing positions during sliding when the sliding direction corresponding to each pressing position is consistent;
determining an angle between each sliding direction and the display screen when the sliding shape meets the third preset sliding shape; and
determining that the target gesture meets the preset gesture when each of the angles is less than or equal to the first preset angle.

19. The electronic device according to claim 15, wherein when determining the gesture type of the target gesture is a palm gesture type, the gesture parameter comprises at least one of the following: a palm moving range, a palm moving direction, a moving path formed in a palm moving range, an angle formed between a palm and a horizontal line during movement, and a palm moving distance;
the determining that the target gesture meets the preset gesture according to the gesture type and/or the gesture parameter, comprises:
determining a palm mistouch parameter corresponding to the palm gesture type, wherein the palm mistouch parameter comprises at least one of the following: a preset palm moving range, a preset moving path, a second preset angle, and a preset palm moving distance; and
determining that the target gesture meets the preset gesture when the palm moving range is in the preset palm moving range, the moving path meets the preset moving path, the angle is less than the second preset angle, and the palm moving distance is greater than or equal to the preset palm moving distance.

20. A computer-readable storage medium, characterized in that computer-readable storage medium stores a computer program for electronic data interchange, wherein the computer program allows a computer to execute a method for unrolling and rolling a rollable screen, and the method comprises:
starting a rollable screen motor in a case where a target gesture for a display screen meets a preset gesture; and
determining a motion parameter of the rollable screen motor according to the target gesture, wherein the motion parameter is configured to indicate that the rollable screen is unrolled to a first preset state or is closed to a second preset state.
